(19) United States
(12) Patent Application Publication
(10) Pub. No.: US 2026/0333387 A1
(43) Pub. Date: Oct. 22, 2026

(54) MODE-1 SIDELINK UNLICENSED OPERATION

(71) Applicant: QUALCOMM Incorporated, San Diego, CA (US)

(72) Inventors: Anantharaman BALASUBRAMANIAN, San Diego, CA (US); Shuanshuan WU, San Diego, CA (US); Stelios STEFANATOS, San Diego, CA (US)

(21) Appl. No.: 19/099,631

(22) PCT Filed: Sep. 15, 2023
(86) PCT No.: PCT/US2023/074403

§ 371 Date: Jan. 29, 2025

(30) Foreign Application Priority Data
Oct. 7, 2022 (GR) 20220100824

(51) Int. Cl. H04W 72/25; H04L 1/16; H04W 72/0453

(52) U.S. Cl. CPC H04W 72/25; H04L 1/16; H04W 72/0453

(57) ABSTRACT

Methods, systems, and devices for wireless communications are described. A first user equipment (UE) may receive a first message indicating a request for the first UE to transmit a set of feedback information to a network entity. The set of feedback information may be associated with transmission of a sidelink message between the first UE and a second UE. The first UE may receive a second message indicating multiple resource sets of a shared radio frequency spectrum band to be used for the transmission of the sidelink message. In response to receiving the request, the first UE may transmit the set of feedback information to the network entity. The feedback information may correspond to the transmission of the sidelink message using a resource set of the multiple resource sets.

### CROSS REFERENCE

The present Application is a 371 national stage filing of International PCT Application No. PCT/US2023/074403 by BALASUBRAMANIAN et al., entitled “MODE-1 SIDELINK UNLICENSED OPERATION,” filed Sep. 15, 2023; and claims priority to Greece Patent Application No. 20220100824 by BALASUBRAMANIAN et al., entitled “MODE-1 SIDELINK UNLICENSED OPERATION,” filed Oct. 7, 2022, each of which is assigned to the assignee hereof, and each of which is expressly incorporated by reference herein.

### FIELD OF TECHNOLOGY

The following relates to wireless communications, including Mode-1 sidelink unlicensed operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless communications systems may support wireless communication using a shared radio frequency spectrum band.

### SUMMARY

The described techniques relate to improved methods, systems, devices, and apparatuses that support Mode-1 sidelink unlicensed operation. For example, the described techniques provide a framework for reporting feedback associated with Mode-1 sidelink operations. In some cases, a first user equipment (UE) may receive a first message indicating a request for the first UE to transmit a set of feedback information to a network entity. In some examples, the set of feedback information may be associated with transmission of a sidelink message between the first UE and a second UE. The first UE may receive a second message indicating multiple resource sets of a shared radio frequency spectrum band to be used at the first UE for the transmission of the sidelink message. In some examples, such as in response to receiving the request, the first UE may transmit the set of feedback information to the network entity. In such cases, the feedback information may correspond to the transmission of the sidelink message using a resource set of the multiple resource sets.

A method for wireless communication at a first UE is described. The method may include receiving, from a network entity, a first message indicating a request for the first UE to transmit a set of feedback information to the network entity, the set of feedback information associated with transmission of a sidelink message between the first UE and at least a second UE, receiving, from the network entity, a second message indicating a set of multiple resource sets of a shared radio frequency spectrum band to be used for the transmission of the sidelink message, and transmitting, to the network entity in response to the first message, the set of feedback information corresponding to the transmission of the sidelink message using at least one resource set of the set of multiple resource sets.

An apparatus for wireless communication at a first UE is described. The apparatus may include a processor, memory coupled with the processor, and instructions stored in the memory. The instructions may be executable by the processor to cause the apparatus to receive, from a network entity, a first message indicating a request for the first UE to transmit a set of feedback information to the network entity, the set of feedback information associated with transmission of a sidelink message between the first UE and at least a second UE, receive, from the network entity, a second message indicating a set of multiple resource sets of a shared radio frequency spectrum band to be used for the transmission of the sidelink message, and transmit, to the network entity in response to the first message, the set of feedback information corresponding to the transmission of the sidelink message using at least one resource set of the set of multiple resource sets.

Another apparatus for wireless communication at a first UE is described. The apparatus may include means for receiving, from a network entity, a first message indicating a request for the first UE to transmit a set of feedback information to the network entity, the set of feedback information associated with transmission of a sidelink message between the first UE and at least a second UE, means for receiving, from the network entity, a second message indicating a set of multiple resource sets of a shared radio frequency spectrum band to be used for the transmission of the sidelink message, and means for transmitting, to the network entity in response to the first message, the set of feedback information corresponding to the transmission of the sidelink message using at least one resource set of the set of multiple resource sets.

A non-transitory computer-readable medium storing code for wireless communication at a first UE is described. The code may include instructions executable by a processor to receive, from a network entity, a first message indicating a request for the first UE to transmit a set of feedback information to the network entity, the set of feedback information associated with transmission of a sidelink message between the first UE and at least a second UE, receive, from the network entity, a second message indicating a set of multiple resource sets of a shared radio frequency spectrum band to be used for the transmission of the sidelink message, and transmit, to the network entity in response to the first message, the set of feedback information corresponding to the transmission of the sidelink message using at least one resource set of the set of multiple resource sets.

In some examples of the method, apparatuses, and non-transitory computer-readable medium described herein, transmitting the set of feedback information may include operations, features, means, or instructions for transmitting the set of feedback information, where, the set of feedback information includes at least one bit, each bit of the at least one bit corresponding to a respective resource set of the at least one resource set, and each bit indicating that the first UE failed to access a communication channel for transmission of the sidelink message using the respective resource set.

In some examples of the method, apparatuses, and non-transitory computer-readable medium described herein, transmitting the set of feedback information may include operations, features, means, or instructions for transmitting the set of feedback information, where the set of feedback information includes a bit indicating that the first UE failed to access a communication channel for transmission of the sidelink message using the set of multiple resource sets.

Some examples of the method, apparatuses, and non-transitory computer-readable medium described herein may further include operations, features, means, or instructions for receiving, from the network entity, an indication of a threshold quantity of resources, where transmitting the set of feedback information may be based on the first UE failing to access the communication channel for transmission of the sidelink message using a quantity of resources that satisfies the threshold quantity of resources.

In some examples of the method, apparatuses, and non-transitory computer-readable medium described herein, the quantity of resources may be included in one or more resource sets of the set of multiple resource sets.

In some examples of the method, apparatuses, and non-transitory computer-readable medium described herein, transmitting the set of feedback information may include operations, features, means, or instructions for transmitting the set of feedback information including at least two bits, where two bits of the at least two bits correspond to a resource set of the at least one resource set, the two bits indicating, that the first UE successfully accessed a communication channel for transmission of the sidelink message using the resource set, that the first UE failed to access a communication channel for transmission of the sidelink message using the resource set, and that the first UE received a negative acknowledgement from the second UE in response to the first UE transmitting the sidelink message using the resource set.

In some examples of the method, apparatuses, and non-transitory computer-readable medium described herein, transmitting the set of feedback information may include operations, features, means, or instructions for transmitting the set of feedback information, where the set of feedback information includes two bits indicating, that the first UE successfully accessed a communication channel for transmission of the sidelink message using the set of multiple resource sets, that the first UE failed to access a communication channel for transmission of the sidelink message using the set of multiple resource sets, and that the first UE received a negative acknowledgement from the second UE in response to the first UE transmitting the sidelink message using the set of multiple resource sets.

Some examples of the method, apparatuses, and non-transitory computer-readable medium described herein may further include operations, features, means, or instructions for transmitting, to the second UE, a third message indicating a request for the second UE to transmit a second set of feedback information to the first UE, where the second set of feedback information associated with the transmission of the sidelink message between the first UE and the second UE, and where the set of feedback information may be based on transmission of the third message.

Some examples of the method, apparatuses, and non-transitory computer-readable medium described herein may further include operations, features, means, or instructions for receiving, from the second UE in response to the third message, the second set of feedback information including a bit that indicates that a received power measured at the second UE satisfies a threshold, where the set of feedback information may be based on the second set of feedback information.

In some examples of the method, apparatuses, and non-transitory computer-readable medium described herein, transmitting the set of feedback information may include operations, features, means, or instructions for transmitting, to the network entity, the set of feedback information based on the second set of feedback information, where the set of feedback information includes two bits indicating, that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, and that the second UE failed to decode the sidelink message transmitted using the at least one resource set.

Some examples of the method, apparatuses, and non-transitory computer-readable medium described herein may further include operations, features, means, or instructions for receiving, from the network entity, a third message indicating a set of resources of a licensed spectrum to be used for transmission of the set of feedback information, where the set of resources may be based on the set of feedback information.

In some examples of the method, apparatuses, and non-transitory computer-readable medium described herein, transmitting the set of feedback information may include operations, features, means, or instructions for receiving, from the network entity, a third message activating a resource set of the set of multiple resource sets and transmitting the set of feedback information including at least one bit indicating that the first UE failed to access a communication channel for transmission of the sidelink message using the activated resource set.

Some examples of the method, apparatuses, and non-transitory computer-readable medium described herein may further include operations, features, means, or instructions for receiving, from the network entity in response to the set of feedback information, a fourth message activating a second resource set of the set of multiple resource sets.

Some examples of the method, apparatuses, and non-transitory computer-readable medium described herein may further include operations, features, means, or instructions for receiving, from the network entity in response to the set of feedback information, a fourth message indicating a resource set unassociated with the set of multiple resource sets.

A method for wireless communication at a network entity is described. The method may include outputting, to a first UE, a first message indicating a request for the first UE to transmit a set of feedback information to the network entity, the set of feedback information associated with transmission of a sidelink message between the first UE and at least a second UE, outputting, to the first UE, a second message indicating a set of multiple resource sets of a shared radio frequency spectrum band to be used for the transmission of the sidelink message, and obtaining, from the first UE in response to the first message, the set of feedback information corresponding to the transmission of the sidelink message using at least one resource set of the set of multiple resource sets.

An apparatus for wireless communication at a network entity is described.

The apparatus may include a processor, memory coupled with the processor, and instructions stored in the memory. The instructions may be executable by the processor to cause the apparatus to output, to a first UE, a first message indicating a request for the first UE to transmit a set of feedback information to the network entity, the set of feedback information associated with transmission of a sidelink message between the first UE and at least a second UE, output, to the first UE, a second message indicating a set of multiple resource sets of a shared radio frequency spectrum band to be used for the transmission of the sidelink message, and obtain, from the first UE in response to the first message, the set of feedback information corresponding to the transmission of the sidelink message using at least one resource set of the set of multiple resource sets.

Another apparatus for wireless communication at a network entity is described. The apparatus may include means for outputting, to a first UE, a first message indicating a request for the first UE to transmit a set of feedback information to the network entity, the set of feedback information associated with transmission of a sidelink message between the first UE and at least a second UE, means for outputting, to the first UE, a second message indicating a set of multiple resource sets of a shared radio frequency spectrum band to be used for the transmission of the sidelink message, and means for obtaining, from the first UE in response to the first message, the set of feedback information corresponding to the transmission of the sidelink message using at least one resource set of the set of multiple resource sets.

A non-transitory computer-readable medium storing code for wireless communication at a network entity is described. The code may include instructions executable by a processor to output, to a first UE, a first message indicating a request for the first UE to transmit a set of feedback information to the network entity, the set of feedback information associated with transmission of a sidelink message between the first UE and at least a second UE, output, to the first UE, a second message indicating a set of multiple resource sets of a shared radio frequency spectrum band to be used for the transmission of the sidelink message, and obtain, from the first UE in response to the first message, the set of feedback information corresponding to the transmission of the sidelink message using at least one resource set of the set of multiple resource sets.

In some examples of the method, apparatuses, and non-transitory computer-readable medium described herein, obtaining the set of feedback information may include operations, features, means, or instructions for obtaining the set of feedback information, where the set of feedback information includes at least one bit, each bit of the at least one bit corresponds to a respective resource set of the at least one resource set and indicates that the first UE failed to access a communication channel for transmission of the sidelink message using the respective resource set.

In some examples of the method, apparatuses, and non-transitory computer-readable medium described herein, obtaining the set of feedback information may include operations, features, means, or instructions for obtaining the set of feedback information, where the set of feedback information includes a bit indicating that the first UE failed to access a communication channel for transmission of the sidelink message using the set of multiple resource sets.

In some examples of the method, apparatuses, and non-transitory computer-readable medium described herein, obtaining the set of feedback information may include operations, features, means, or instructions for outputting, to the first UE, an indication of a threshold quantity of resources and obtaining the set of feedback information based on the first UE failing to access the communication channel for transmission of the sidelink message using a quantity of resources that satisfies the threshold quantity of resources.

In some examples of the method, apparatuses, and non-transitory computer-readable medium described herein, the quantity of resources may be included in one or more resource sets of the set of multiple resource sets.

In some examples of the method, apparatuses, and non-transitory computer-readable medium described herein, obtaining the set of feedback information may include operations, features, means, or instructions for obtaining the set of feedback information, where the set of feedback information includes at least two bits, and where two bits of the at least two bits corresponds to a resource set of the at least one resource set, the two bits indicating, that the first UE successfully accessed a communication channel for transmission of the sidelink message using the resource set, that the first UE failed to access a communication channel for transmission of the sidelink message using the resource set, and that the first UE received a negative acknowledgement from the second UE in response to the first UE transmitting the sidelink message using the resource set.

In some examples of the method, apparatuses, and non-transitory computer-readable medium described herein, obtaining the set of feedback information may include operations, features, means, or instructions for obtaining the set of feedback information, where the set of feedback information includes two bits indicating, that the first UE successfully accessed a communication channel for transmission of the sidelink message using the set of multiple resource sets, that the first UE failed to access a communication channel for transmission of the sidelink message using the set of multiple resource sets, and that the first UE received a negative acknowledgement from the second UE in response to the first UE transmitting the sidelink message using the set of multiple resource sets.

In some examples of the method, apparatuses, and non-transitory computer-readable medium described herein, the set of feedback information may be based on a second set of feedback information communicated between the first UE and the second UE.

In some examples of the method, apparatuses, and non-transitory computer-readable medium described herein, obtaining the set of feedback information may include operations, features, means, or instructions for obtaining the set of feedback information, where the set of feedback information includes two bits indicating, that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, and that the second UE failed to decode the sidelink message transmitted using the at least one resource set.

Some examples of the method, apparatuses, and non-transitory computer-readable medium described herein may further include operations, features, means, or instructions for outputting, to the first UE, a third message indicating a set of resources of a licensed spectrum to be used for transmission of the set of feedback information, where the set of resources may be based on the set of feedback information.

In some examples of the method, apparatuses, and non-transitory computer-readable medium described herein, obtaining the set of feedback information may include operations, features, means, or instructions for outputting, to the first UE, a third message activating a resource set of the set of multiple resource sets and obtaining, from the first UE, the set of feedback information including at least one bit indicating that the first UE failed to access a communication channel for transmission of the sidelink message using the activated resource set.

Some examples of the method, apparatuses, and non-transitory computer-readable medium described herein may further include operations, features, means, or instructions for outputting, to the first UE in response to the set of feedback information, a fourth message activating a second resource set of the set of multiple resource sets.

Some examples of the method, apparatuses, and non-transitory computer-readable medium described herein may further include operations, features, means, or instructions for outputting, to the first UE in response to the set of feedback information, a fourth message indicating a resource set unassociated with the set of multiple resource sets.

### BRIEF DESCRIPTION OF THE DRAWINGS

FIGS. 1 and 2 each illustrate an example of a wireless communications system that supports Mode-1 sidelink unlicensed operation in accordance with one or more aspects of the present disclosure.

FIG. 3 illustrates an example of a process flow that supports Mode-1 sidelink unlicensed operation in accordance with one or more aspects of the present disclosure.

FIGS. 4 and 5 show block diagrams of devices that support Mode-1 sidelink unlicensed operation in accordance with one or more aspects of the present disclosure.

FIG. 6 shows a block diagram of a communications manager that supports Mode-1 sidelink unlicensed operation in accordance with one or more aspects of the present disclosure.

FIG. 7 shows a diagram of a system including a device that supports Mode-1 sidelink unlicensed operation in accordance with one or more aspects of the present disclosure.

FIGS. 8 and 9 show block diagrams of devices that support Mode-1 sidelink unlicensed operation in accordance with one or more aspects of the present disclosure.

FIG. 10 shows a block diagram of a communications manager that supports Mode1 sidelink unlicensed operation in accordance with one or more aspects of the present disclosure.

FIG. 11 shows a diagram of a system including a device that supports Mode-1 sidelink unlicensed operation in accordance with one or more aspects of the present disclosure.

FIGS. 12 through 15 show flowcharts illustrating methods that support Mode-1 sidelink unlicensed operation in accordance with one or more aspects of the present disclosure.

### DETAILED DESCRIPTION

Some wireless communications systems may include communication devices, such as user equipments (UEs) or network entities, that support wireless communications using one or more radio access technologies (RATs). For example, the communication devices may support wireless communications using one or multiple cellular RATs, such as fourth generation (4G) systems (e.g., Long Term Evolution (LTE) systems), and fifth generation (5G) systems (e.g., New Radio (NR) systems), among other generations, including subsequent generations, of cellular RATs. In some examples, such wireless communications systems may support sidelink communications using a shared radio frequency spectrum band (e.g., an unlicensed radio frequency spectrum band, an unlicensed band) that may be shared between cellular RATs, one or more other RATs, such as Wi-Fi or Bluetooth, among other examples. In some examples, a network entity may allocate resources of the shared radio frequency spectrum band to a first UE for sidelink communications.

In such examples, prior to using the allocated resources of the shared radio frequency spectrum band for a transmission, the first UE may perform a channel access procedure. For example, the first UE may perform a listen-before-talk (LBT) procedure to determine whether the allocated resources may be available (or unavailable) for the transmission. In some examples, irrespective of the resources being allocated to the first UE, the first UE may be incapable of using the allocated resources. For example, the LBT procedure performed at the first UE (e.g., to gain access to a channel to use the allocated resources) may fail. Additionally, or alternatively, the first UE may be capable of transmitting a sidelink message using the allocated resources (e.g., the LBT procedure may be successful), but may fail to receive feedback from a second UE to which the sidelink message was transmitted. For example, an LBT procedure performed at the second UE may fail. Additionally, or alternatively, the first UE may receive feedback from the second UE (e.g., in response to transmitting the sidelink message), but the feedback may indicate a negative acknowledgement, which may be indicative of relatively high interference at the second UE.

Additionally, or alternatively, while the network entity may allocate resources of the shared radio frequency spectrum band to the first UE, the network entity may be unaware of communication failures experienced at the first UE (or the second UE) using the allocated resources. For example, the network entity may be unaware of LBT failures or relatively high interference experienced at the first UE or the second UE. In such cases, the network entity may be incapable of mitigating the failures or interference. For example, the network entity may be incapable of determining whether to re-allocate resources to the first UE or adjust one or more transmission parameters used at the first UE for the sidelink transmissions.

Various aspects of the present disclosure generally relate to techniques for Mode-1 sidelink unlicensed operation, and more specifically, to a framework for reporting feedback associated with Mode-1 sidelink operations. As described herein, Mode-1 sidelink operations may correspond to sidelink operations in which a network entity may allocate resources to a UE for sidelink communications. For example, the network entity may allocate one or more sets of resources of the shared radio frequency spectrum band to the first UE. In such an example, the network entity may indicate, to the first UE, a request for feedback information corresponding to the allocated resource sets. In some examples, such as in response to receiving the request, the first UE may transmit one-bit feedback corresponding to one or more of the allocated resource sets to the network entity. In such examples, the one-bit feedback may indicate whether the first UE successfully accessed a communication channel for a transmission using one or more of the allocated resource sets. The one-bit feedback may correspond to an allocated resource set (e.g., the UE may report the one-bit feedback for the allocated resource sets independently) or multiple allocated resource sets (e.g., the UE may report collective one-bit feedback for the allocated resource sets).

Additionally, or alternatively, the first UE may transmit two-bit feedback corresponding to one or more of the allocated resource sets to the network entity. In some examples, the two-bit feedback may indicate whether the first UE successfully accessed a communication channel for a transmission using an allocated resource set. Additionally, or alternatively, if the first UE failed to access a communication channel for the transmission using the allocated resource set, the two-bit feedback may indicate information associated with the failure. The first UE may transmit respective (e.g., independent) two-bit feedback for the allocated resource sets or collective two-bit feedback for the allocated resource sets. In some examples, the network entity may allocate resources of another radio frequency spectrum band (e.g., a licensed radio frequency spectrum band) to the first UE for transmission of the one-bit feedback or the two-bit feedback. In some examples, such as examples in which the first UE fails to receive feedback from the second UE (e.g., in response to transmitting a sidelink message) or receives a negative acknowledgement from the second UE, the first UE may transmit a request for information associated with the failure (or negative acknowledgement) from the second UE. In some examples, transmitting one-bit or two-bit feedback to the network entity regarding Mode-1 sidelink operations may lead to increased resource utilization of the shared radio frequency spectrum band, among other possible benefits.

Aspects of the disclosure are initially described in the context of wireless communications systems and a process flow. Aspects of the disclosure are further illustrated by and described with reference to apparatus diagrams, system diagrams, and flowcharts that relate to Mode-1 sidelink unlicensed operation.

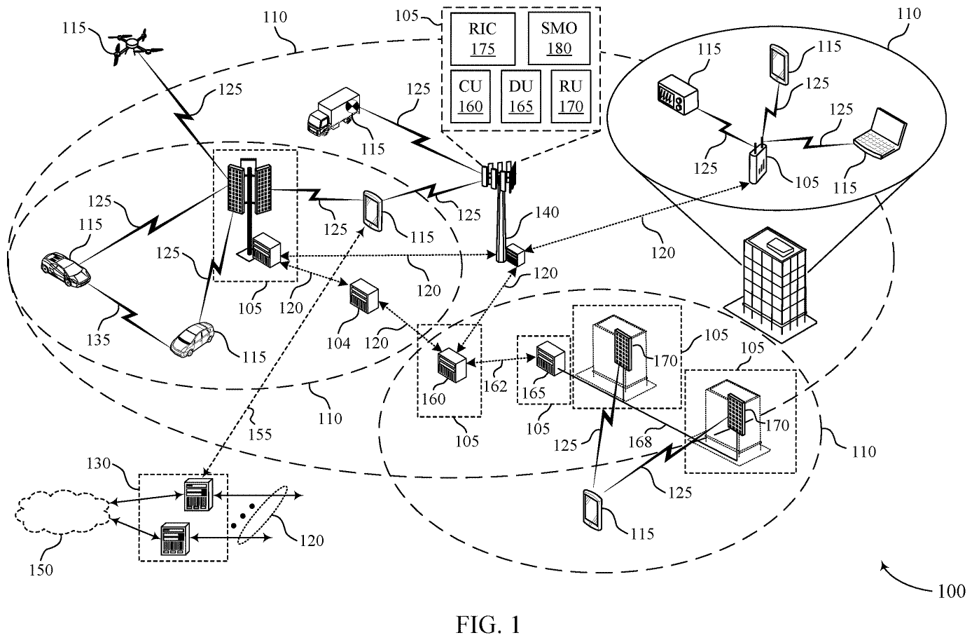

FIG. 1 illustrates an example of a wireless communications system 100 that supports Mode-1 sidelink unlicensed operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support Mode-1 sidelink unlicensed operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N₇₁) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support a framework for reporting feedback associated with Mode-1 sidelink operations. For example, a first UE 115 may receive a first message from a network entity 105 indicating a request for the first UE 115 to transmit a set of feedback information to the network entity 105. In some examples, the set of feedback information may be associated with transmission of a sidelink message between the first UE 115 and a second UE 115. The first UE 115 may receive a second message from the network entity 105 indicating multiple resource sets of a shared radio frequency spectrum band to be used for the transmission of the sidelink message. In some examples, such as in response to receiving the request, the first UE 115 may transmit the set of feedback information to the network entity 105. In such examples, the set of feedback information may correspond to the transmission of the sidelink message using a resource set of the multiple resource sets. In some examples, the framework for reporting feedback associated with Mode-1 sidelink operations may lead to increased resource utilization within the wireless communications system 100, among other possible benefits.

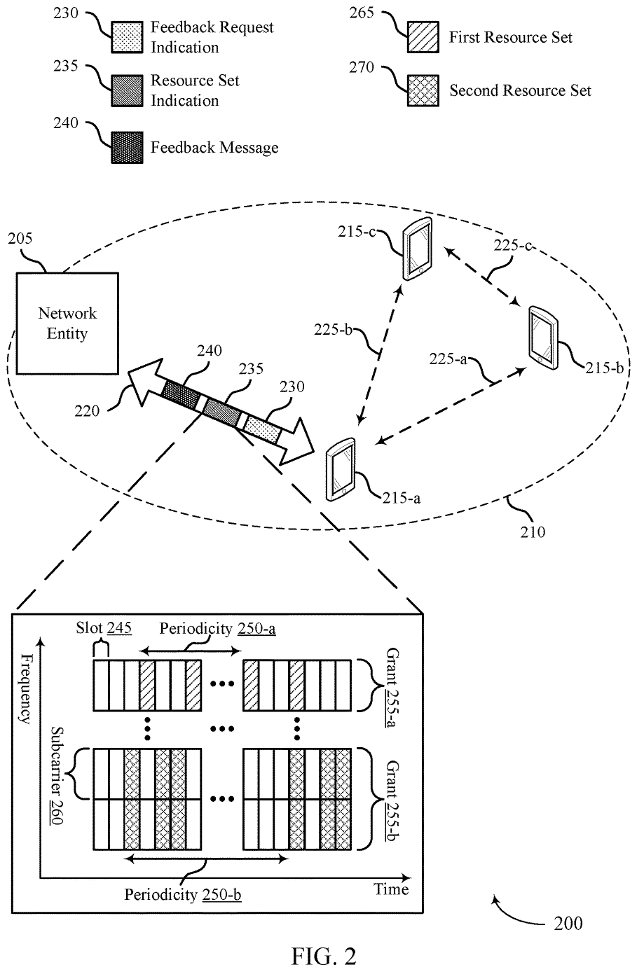

FIG. 2 illustrates an example of a wireless communications system 200 that supports Mode-1 sidelink unlicensed operation in accordance with one or more aspects of the present disclosure. In some examples, the wireless communications system 200 may implement aspects of the wireless communications system 100. For example, the wireless communications system 200 may include a UE 215-a, a UE 215-b, and a UE 215-c, which may be examples a UE 115 as described with reference to FIG. 1. In the example of FIG. 2, the UEs 215 may communicate using one or more sidelinks 225 (e.g., a PC5 interface). In some examples, the one or more sidelinks 225 (e.g., a sidelink 225-a, a sidelink 225-b, and a sidelink 225-c) may be examples of a D2D communication link 135 as described with reference to FIG. 1. The wireless communications system may also include a network entity 205, which may be an example of a network entity 105, as described with reference to FIG. 1. In the example of FIG. 2, the network entity 205 may communicate with the UE 215-a (or one or more other UEs, such as the UE 215-b or the UE 215-c) using a communication link 220 (e.g., a Uu interface), which may be an example of communication link 125 as described with reference to FIG. 1. The network entity 205 and the UEs 215 may communicate within a coverage area 210, which may be an example of a coverage area 110 as described with reference to FIG. 1.

In some examples, the wireless communications system may support Mode-1 sidelink operations in which the network entity 205 (e.g., a gNB) may allocate resources for sidelink communication between the UEs 215. In some examples, multiple (e.g., two) modes may be used at the network entity 205 to provide resources (e.g., allocate resources) to the UEs 215 for sidelink transmissions. For example, the network entity 205 may use a dynamic grant to indicate (e.g., grant) resources to one or more of the UEs 215 for a sidelink transmission (e.g., for each transmission or retransmission of a transport block in sidelink). Additionally, or alternatively, the network entity 205 may use a configured grant to allocate (e.g., assign) resources in sets (e.g., chunks), which may occur periodically. In some examples, the network entity may allocate multiple configured grants to one or more of the UEs 215. As illustrated in the example of FIG. 2, the network entity 205 may use a resource set indication 235 to configure the UE 215-a with a grant 255-a of a first resource set 265, which may have a periodicity 250-a. Additionally, or alternatively, the network entity 205 may use the resource set indication 235 to configure the UE 215-a with a grant 255-b of a second resource set 270, which may have a periodicity 250-b. In some examples, the grant 255-a (e.g., the first resource set 265) and the grant 255-b (e.g., the second resource set 270) may be each be associated with one or more frequency domain resources (e.g., one or more of a subcarrier 260) and one or more time domain resources (e.g., one or more of a slot 245).

In some examples of Mode-1 sidelink operations, the network entity 205 may configure multiple types of configured grant schemes at the UE 215-a. For example, the network entity 205 may use (e.g., define) two types of configured grant schemes and indicate the configured grant schemes to the UE 215-a using control signaling, such as RRC signaling. In some examples, the network entity 205 may transmit control signaling that indicates, to the UE 215-a, a configured grant Type-1, which may be utilized at the UE 215-a prior to (e.g., until) the network entity 205 may release the configured grant Type-1 (e.g., using RRC signaling). For example, the UE 215-a may utilize the configured grant Type-1 in response to receiving the control signaling (e.g., immediately, during some suitable duration subsequent to a time instance during which the control signaling may be received at the UE 215-a).

Additionally, or alternatively, the network entity 205 may indicate a configured grant Type-2 to the UE 215-a, which may be utilized at the UE 215-a in response to the configured grant Type-2 being activated. For example, the network entity 205 may transmit control signaling, such as downlink control information (DCI), activating the configured grant Type-2 (e.g., one or more resource sets associated with the configured grant Type-2) at the UE 215-a. In such an example, the UE 215-a may utilize the configured grant Type-2 (e.g., the one or more resource sets associated with the configured grant Type-2) in response to receiving the control signaling.

In some examples, the network entity 205 may enable feedback for groupcast or unicast communications at the UE 215-a. For example, the UE 215-a may use one or more resource sets allocated to the UE 215-a to transmit a groupcast or unicast communication (e.g., a packet) to the UE 215-b or the UE 215-c, or both. In some examples, the UE 215-b and the UE 215-c (e.g., receiving UEs) mat successfully receive the packet transmitted from the UE 215-a. In such an example, the UE 215-a (e.g., a transmitting UE) may provide an acknowledgement to the network entity 205. Additionally, or alternatively, in some examples, one or both of the UE 215-b and the UE 215-c may fail to receive the packet transmitted from the UE 215-a. In such examples, the UE 215-a may provide a negative acknowledgement to the network entity 205. In some examples, the UE 215-a may transmit the feedback (e.g., the acknowledgement or negative acknowledgement) to the network entity 205 using resources allocated to the UE 215-a from the network (e.g., a configured physical uplink control channel (PUCCH)). For example, the UE 215-a may transmit the feedback to the network entity 205 using the configured PUCCH.

In some examples, the UE 215-a may transmit the feedback to the network entity 205 subsequent to the UE 215-a receiving feedback (e.g., a physical sidelink feedback channel (PSFCH)) associated with a relatively last resource among a set of resources allocated to the UE 215-a. In such examples, the set of resources may be allocated to the UE 215-a using a dynamic grant. Additionally, or alternatively, the UE 215-a may transmit the feedback to the network entity 205 subsequent to a relatively last resource within a configured grant period associated with a set of resources allocated to the UE 215-a. In such examples, the set of resources may be allocated to the UE 215-a using a configured grant. In some examples, the UE 215-a may indicate the feedback to the network entity 205 using a bit. That is, one-bit feedback may be reported to the network entity 205 from the UE 215-a.

In some examples, the wireless communications system 200 may support sidelink communication using the shared radio frequency spectrum band (e.g., the unlicensed spectrum). For example, the wireless communications system 200 may support use of the shared radio frequency spectrum for both Mode-1 sidelink and Mode-2 sidelink operations. In such an example, Uu operations for Mode-1 sidelink (e.g., operations associated with communications using a Uu interface) may be constrained to another radio frequency spectrum band (e.g., the licensed spectrum) for one or more deployments (e.g., RAN1, RAN2, RAN4). In some examples, channel access mechanisms for operations using the shared radio frequency spectrum band (e.g., for NR-unlicensed (NR-U) may be used (or reused) for sidelink operations (e.g., sidelink unlicensed operations). In such examples, resource reservations for the sidelink communications (e.g., sidelink resource reservations) using the shared radio frequency spectrum band may include one or more aspects of an unlicensed channel access mechanism or operation. For example, sidelink resources reservations using the shared radio frequency spectrum may include one or more aspects of NR sidelink physical channel structures and procedures.

As illustrated in the example of FIG. 2, the UEs 215 may operate in Mode-1 sidelink using the shared radio frequency spectrum band. For example, the network entity 205 may allocate resources of the shared radio frequency spectrum band to the UE 215-a for a unicast transmission to the UE 215-b or the UE 215-c or for a groupcast transmission to (e.g., groupcast operations with) the UE 215-b and the UE 215-c. In such an example, communications between the UEs 215 and the network entity 205 may occur using Uu links (e.g., the communication link 220, the Uu interface), which may operate using licensed bands. In some examples, irrespective the UE 215-a being allocated resources, the UE 215-a may be unable to transmit using the allocated resources. For example, the UE 215-a may fail to successfully complete (e.g., may be unsuccessful in clearing) an LBT procedure. That is, the UE 215-a may be unable to access a channel to use the allocated resources due to an unsuccessful LBT procedure.

Additionally, or alternatively, the UE 215-a may be able to transmit a message to one or both of the UE 215-b and the UE 215-c, however the UE 215-a may fail to receive feedback corresponding to the message from one or both of the UE 215-b and the UE 215-c. In some examples, an inability (or failure) to receive feedback at the UE 215-a may be due to one or both of the UE 215-b and the UE 215-c failing to successfully complete an LBT procedure to transmit the feedback to the UE 215-a. In some examples, the UE 215-a may be able to transmit the message to one or both of the UE 215-b and the UE 215-c, but may receive a negative acknowledgement from one or both of the UE 215-b and the UE 215-c. In some examples, a negative acknowledgement from one or both of the UE 215-b and the UE 215-c (e.g., the receivers) may be due to a decoding failure or a presence of relatively high interference at the respective UE (e.g., at the receivers).

In some examples, while the network entity may allocate resources of the shared radio frequency spectrum band to the UE 215-a for the unicast or groupcast transmission, the network entity may be unaware of communication failures experienced at the UE 215-a (or the UE 215-b, or the UE 215-c) using the allocated resources. For example, the network entity may be unaware of LBT failures or decoding failures (e.g., due to relatively high interference) experienced at the UE 215-a, the UE 215-b or the UE 215-c. That is, the UE 215-a may lack a mechanism to inform the network entity 205 of communication failures, such as LBT failures, for example if the UE 215-a is allocated resources from the network entity 205 using a dynamic grant or a configured grant.

In some examples, a framework for reporting feedback associated with Mode-1 sidelink operations, as described herein, may provide one or more enhancements to Mode-1 sidelink operations using the shared radio frequency spectrum band. For example, the framework for reporting feedback associated with Mode-1 sidelink operations, as described herein, may provide for enhanced (e.g., relatively more expressive) feedback messages in sidelink and Uu link, such that the network entity 205 may be capable of allocating (or re-allocating) resources to the UE 215-a based on one or more communication failures. That is, one or more frameworks for reporting feedback associated with Mode-1 sidelink operations, as described herein, may provide a mechanism (e.g., actions) for the network entity 205 to mitigate communication failures experienced at one or more of the UEs 215.

For example, some techniques for Mode-1 sidelink unlicensed, as described herein, may enable one or more mechanisms at the UE 215-a (e.g., a transmitting UE) for providing feedback to the network entity 205, for example if the UE 215-a fails to successfully complete an LBT procedure for a transmission, irrespective the network entity 205 providing resources for the transmission. For example, the UE 215-a may receive a feedback request indication 230 indicating a request for the UE 215-a to transmit a feedback message 240 indicating a set of feedback information to a network entity 205. The set of feedback information may be associated with transmission of a sidelink message between the UE 215-a and one or both of the UE 215-b and the UE 215-c. Additionally, or alternatively, the UE 215-a may receive the resource set indication 235 indicating multiple resource sets of the shared radio frequency spectrum band (e.g., the first resource set and the second resource set) to be used for the transmission of the sidelink message. In response to receiving the request, the UE 215-a may transmit the set of feedback information to the network entity 205.

In some examples, the set of feedback information may indicate a negative acknowledgement. For example, UE 215-a may transmit a negative acknowledgement to the network entity 205 using the set of feedback information if the UE 215-a fails to successfully complete an LBT procedure for transmission of the sidelink message. Additionally, or alternatively, the set of feedback information may indicate an acknowledgement. For example, UE 215-a may transmit an acknowledgement to the network entity 205 using the set of feedback information if the UE 215-a successfully completes an LBT procedure for transmission of the sidelink message. In some examples, the resource set indication 235 may correspond to a dynamic grant resource allocation from the network entity 205. In such an example, the UE 215-a may transmit the feedback information using a bit. For example, the UE 215-a may transmit a one-bit negative acknowledgement or a one-bit acknowledgement. In some other examples, the resource set indication 235 may correspond to a configured grant resource allocation from the network entity 205. In such examples, the UE 215-a may provide a one-bit feedback (e.g., the one-bit negative acknowledgement or the one-bit acknowledgement) for a configured grant type transmission (e.g., each configured grant type transmission). For example, if the network entity 205 configures the UE 215-a with the grant 255-a and the grant 255-b, the UE 215-a may transmit a one-bit feedback for the grant 255-a and another one-bit feedback for the grant 255-b (e.g., independently).

Additionally, or alternatively, the UE 215-a may provide a one-bit feedback (e.g., the one-bit negative acknowledgement or a one-bit acknowledgement) for multiple configured grant type transmissions (e.g., multiple resource sets). For example, if the network entity 205 configures the UE 215-a with the grant 255-a and the grant 255-b, the UE 215-a may transmit a one-bit feedback for the grant 255-a and the grant 255-b (e.g., collectively). In some examples, the UE 215-a may provide a one-bit negative acknowledgement, if the UE 215-a fails to successful complete an LBT procedure for a threshold percentage (e.g., x %) of the configured grants (e.g., resources associated with the configured grants). For the example, the UE 215-a may transmit the one-bit negative acknowledgement if the UE 215-a fails to successfully complete an LBT procedure (e.g., is unable to access a communication channel) for a transmission using a threshold quantity of resources (e.g., one or multiple resources) included in the first resource set 265 or the second resource set 270. In some examples, the threshold (x) for reporting feedback (e.g., the one-bit negative acknowledgement) may be configured at the UE 215-a, for example using signaling (e.g., RRC signaling) from the network entity 205.

In some examples, such as in response to receiving the one-bit negative acknowledgement from the UE 215-a, the network entity 205 may allocate a re-transmission opportunity using control signaling (e.g., DCI). For example, the network entity 205 may transmit the control signaling re-allocating resources to the UE 215-a based on the one-bit negative acknowledgement. Additionally, or alternatively, the network entity 205 may modify a power assignment or modulation and coding scheme (MCS) assignment for the UE 215-a. That is, in response to receiving the one-bit negative acknowledgement, the network entity 205 may perform one or more operations to mitigate communication failures at the UE 215-a. In some examples, however, the network entity may be unable to determine how to mitigate communication failures experience at the UE 215-a based on the one-bit feedback. For example, if the network entity 305 is unaware of a failure associated with the one-bit negative acknowledgement, the network entity 205 may be unable to determine whether to re-allocate resources, modify a power assignment, or modify MCS assignment (or perform some combination thereof) to suitably mitigate the failure associated with the one-bit negative acknowledgement. As such, in some examples, the UE 215-a may transmit two-bit feedback that may indicate a negative acknowledgement and a failure associated with the negative acknowledgement (e.g., a trigger for transmitting the negative acknowledgement). Transmitting one-bit and two-bit feedback to the network entity 205 may enable the network entity 205 to mitigate communication failures experienced at one or more of the UEs 215, among other possible benefits.

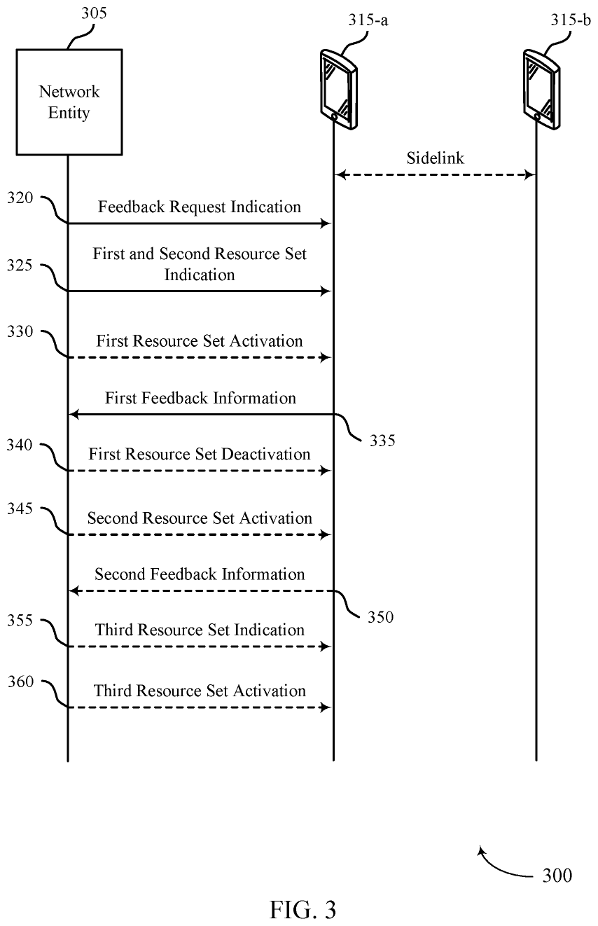

FIG. 3 illustrates an example of a process flow 300 that supports Mode-1 sidelink unlicensed operation in accordance with one or more aspects of the present disclosure. The process flow 300 may implement or be implemented at or using one or more aspects of the wireless communications system 100 and the wireless communications system 200. For example, the process flow 300 may be implemented at a network entity 305, a UE 315-a, and a UE 315-b, which may be examples of the corresponding devices as described with reference to FIGS. 1 and 2. In some examples, the network entity 305, the UE 315-a, and the UE 315-b may implement the process flow 300 to promote network efficiencies by supporting a framework for reporting feedback associated with Mode-1 sidelink operations. The process flow 300 may also be implemented by the network entity 305, the UE 315-a, and the UE 315-b to promote high reliability and low latency operations, among other possible benefits. In the following description of the process flow 300, the operations between the network entity 305, the UE 315-a, and the UE 315-b may occur in a different order than the example order shown, or the operations performed at the UEs 315 may be performed in different orders or at different times. Some operations may also be omitted. In some examples, the operations performed at network entity 305, the UE 315-a, and the UE 315-b may support a framework for reporting feedback associated with Mode-1 sidelink operations.

At 320, the UE 315-a may receive a feedback request indication that may indicate a request for the UE 315-a to transmit a set of feedback information to the network entity 305. The feedback request indication may be an example of a feedback request indication as described throughout the present disclosure, including with reference to FIG. 2. For example, the feedback request indication may indicate a request for the UE 315-a to transmit a set of feedback information associated with sidelink communications, such as transmission of a sidelink message, between the UE 315-a and the UE 315-b.

A 325, the UE 315-a may receive a first and second resource set indication. The first and second resource set indication may be an example of a resource set indication as described throughout the present disclosure, including with reference to FIG. 2. For example, the first and second resource set indication may indicate multiple resource sets of a shared radio frequency spectrum band to be used at the UE 315-a for the transmission of the sidelink message. That is, the first and second resource set indication may indicate a first resource set of the shared radio frequency spectrum band and a second resource set of the shared radio frequency spectrum band that may be used at the UE 315-a for sidelink communications. In some examples, the first resource set and the second resource set (e.g., indicated using the first and second resource set indication) may be indicated using one or more configured grants. For example, the first resource set may be indicated to the UE 315-a using a first configured grant and the second resource set may be indicated to the UE 315-a using a second configured grant.

In some examples, the first configured grant and the second configured grant may each be examples of a configured grant Type-2 as described throughout the present disclosure, including with reference to FIG. 2. For example, the UE 315-a may utilize the first resource set or the second resource set in response to the configured grant Type-2 being activated using signaling (e.g., DCI) from the network entity 305. For example, at 330, the UE 315-a may receive a first resource set activation indication. In response to the first resource set activation indication, the UE 315-a may transmit or attempt to transmit a sidelink message to the UE 315-b using the first resource set.

At 335, the UE 315-b may transmit a first feedback message indicating first feedback information to the network entity 305. The first feedback information may be an example of a set of feedback information as described throughout the present disclosure, including with reference to FIG. 2. For example, the first feedback information may correspond to transmission of the sidelink message using the first resource set. In some examples, the first feedback information may include one-bit feedback corresponding to the first configured grant (e.g., the first resource set). For example, the first feedback information may include a one-bit negative acknowledgement indicating that the UE 315-a failed to access a communication channel for transmission of the sidelink message using the first resource set. In some examples, such as in response to receiving the one-bit negative acknowledgement from the UE 315-a, the network entity 305 may determine to re-allocate resources to the UE 315-a based on the one-bit negative acknowledgement. Additionally, or alternatively, the network entity 305 may determine to modify a power assignment or MCS assignment for the UE 315-a. In some examples, however, the network entity may be unable to determine whether to re-allocate resources, modify the power assignment, or modify the MCS assignment (or perform some combination thereof), for example if the network entity 305 is unaware of a failure associated with the one-bit negative acknowledgement. As such, in some examples, the first feedback information may include two-bit feedback, such that the UE 315-a may indicate a negative acknowledgement and a failure associated with the negative acknowledgement (e.g., a trigger for transmitting the negative acknowledgement).

In some examples, to indicate the failure associated with the negative acknowledgement, the UE 315-a may indicate that the UE 315-a failed to successfully complete an LBT for the sidelink transmission. Additionally, or alternatively, the UE 315-a may indicate that the UE 315-a received a negative acknowledgement from the UE 315-b (e.g., in response to a sidelink transmission, such as the sidelink message). In some examples, the UE 315-a may request (e.g., elicit) detailed feedback from the UE 315-b, such that the UE 315-a may provide a relatively more detailed report to the network entity 305.

In some examples, the UE 315-a may provide two-bit feedback to indicate an acknowledgement, that the UE 315-a failed to successfully complete an LBT procedure for transmission of the sidelink message, or that the UE received a negative acknowledgement from the UE 315-b, or some combination thereof. In some examples in which the first resource set may be configured at the UE 315-a using a dynamic grant resource allocation from the network entity 205, the UE 315-a may transmit a two-bit negative acknowledgement that indicates that the UE 315-a failed to successfully complete an LBT procedure for transmission of the sidelink message or that the UE received a negative acknowledgement. In some other examples in which the first resource set is configured at the UE 315-a using a configured grant resource allocation from the network entity 305, the UE 315-a may provide two-bit feedback for multiple (e.g., each) configured grant type transmission. For example, the network entity 305 may configure the UE 215-a with multiple resource sets (e.g., using the first grant and the second grant). In such an example, the UE 315-a may transmit two-bit feedback for the first grant and two-bit feedback for the second (e.g., independently). Additionally, or alternatively, the UE 315-a may transmit two-bit feedback for both the first grant and the second grant.

In some examples in which the first resource set is indicated to the UE 315-a using a configured grant, the first feedback information (e.g., transmitted at 340) may indicate a two-bit negative acknowledgement for the first grant. For example, the first feedback information may indicate a negative acknowledgement and a failure associated with the negative acknowledgement. In some examples, the two-bit negative acknowledgement may indicate that the UE 315-a failed to successfully complete an LBT procedure (e.g., that the negative acknowledgement was due to an LBT failure). In such examples, the network entity 305 may determine to allocate (or re-allocate) another resource set, for example to mitigate the LBT failure. For example, the network entity 305 may determine to allocate another resource set for retransmission of the sidelink message using another sub-channel, one or more other frequencies, or another physical resource block. In some examples, the network entity 305 may assign another resource set through deactivation of the first resource set and activation of the second resource set. For example, at 340, the UE 315-a may receive a first resource set deactivation indication from the network entity 305. Additionally, or alternatively, at 345, the UE 315-a may receive a second resource set activation indication. In such an example, such as in response to receiving the second resource set activation indication, the UE 315-a may use the second resource set to transmit or attempt to transmit the sidelink message to the UE 315-b.

In some examples in which the first resource set is indicated to the UE 315-a using a dynamic grant, the first feedback information may indicate that the UE 315-a failed to successfully complete an LBT procedure (e.g., that the negative acknowledgement was due to an LBT failure). In such examples, the network entity 305 may configure (or reconfigure, such as using a update) another resource set using a configured grant (e.g., may configure the UE 315-a with configured grant resources). For example, at 350 the UE 315-a may transmit a second feedback message indicating second feedback information to the network entity 305. The second feedback information may be an example of a set of feedback information as described throughout the present disclosure, including with reference to FIG. 2. For example, the second feedback information may correspond to transmission of the sidelink message using the second resource set. In some examples, the second feedback information may include a two-bit negative acknowledgement. For example, the second feedback information may indicate a negative acknowledgement and a failure associated with the negative acknowledgement. In some examples, the negative acknowledgement may transmitted from the UE 315-a in response to the UE 315-a failing to successfully complete an LBT procedure using the first resource set and the second resource set. In such an example, the UE 315-a may indicate a negative acknowledgement corresponding to the first configured grant (e.g., the first resource set) and the second configured grant (e.g., the second resource set) and may indicate that the negative acknowledgement is due to the UE 315-a failing to successfully complete one or more LBT procedures. In such an example, the network entity 305 may use another configured grant to allocate another resource set to the UE 315-a.

For example, at 355, the UE 315-a may receive a third resource set indication. The third resource set indication may be an example of a resource set indication as described throughout the present disclosure, including with reference to FIG. 2. For example, the third resource set indication may indicate a resource sets of a shared radio frequency spectrum band to be used for the transmission of the sidelink message. In some examples, the third resource set may be indicated using a third configured grant. The third configured grant (e.g., the third resource set) may be associated with, such as located in, another (e.g., a different) subchannel, one or more other frequencies, or another physical resource block, among other examples. For example, the network entity 305 may indicate the third configured grant in another subchannel or physical resource block to mitigate effects of an LBT failure that may be due to interference (e.g., at the UE 315-a or the UE 315-b). In some examples, the third configured grant may be an example of a configured grant Type-2. For example, at 360, the UE 315-a may receive a third resource set activation indication. In some examples, the third resource set activation indication may be indicated to the UE 315-a using DCI. In response to the third resource set activation indication, the UE 315-a may transmit or attempt to transmit a sidelink message to the UE 315-b using the third resource set.

In some examples, although the UE 315-a (e.g., a transmitting UE) may gain access to a communication channel (e.g., may obtain an opportunity) to transmit the sidelink message (e.g., after successfully completing an LBT procedure, after clearing LBT), the UE 315-b (e.g., the receiving UE) may fail to gain access to the communication channel (or some other communication channel) to transmit feedback. For example, the UE 315-b may fail to successfully complete an LBT procedure. Additionally, or alternatively, the UE 315-b may fail to decode the sidelink message, for example due to relatively high interference. In some examples, the UE 315-a may be configured to request feedback from the UE 315-b, such that the UE 315-a may transmit an enhanced sidelink report to the network entity 305. For example, the UE 315-a may be configured to transmit enhanced sidelink reports for feedback reporting from the UE 315-b. In some examples, the UE 315-a may configure the UE 315-b to measure a received power (e.g., reference signal received power (RSRP), received signal strength indicator (RSSI)) associated with resources used at the UE 315-b to receive the sidelink message (e.g., physical sidelink shared channel (PSSCH) transmissions) from the UE 315-a. Additionally, or alternatively, the UE 315-a may configure the UE 315-b to measure a received power associated with resources used at the UE 315-b to transmit feedback (e.g., feedback resources, PSFCH transmissions) to the UE 315-a. The UE 315-b may report the measured received power to the UE 315-a, for example with the feedback (e.g., with an acknowledgement or a negative acknowledgement). In some examples, the UE 315-b may report the measured receive power using an indicator bit (e.g., with the feedback). For example, the UE 315-b may transmit an indicator bit corresponding to the measured receive power if a value associated with the measured received power satisfies a threshold (e.g., an absolute value of a measured RSSI is greater than a threshold). Additionally, or alternatively, the UE 315-b may report an indicator bit corresponding to the measured received power (e.g., with the feedback) if a ratio of multiple received power measurements satisfies a threshold. For example, the UE 315-b may transmit the indicator bit corresponding to the measured received power if a ratio between a measured RSRP and a measured RSSI satisfies a threshold (e.g., the ratio between the measured RSRP and the measured RSSI is less than a threshold). In some examples, the indicator bit corresponding to the received power measurement may aid the UE 315-b in determining a failure (e.g., cause, trigger) associated with a negative acknowledgement. For example, the indicator bit may aid the UE 315-a in determining whether the negative acknowledgement was due to a decoding failure, relatively high interference, or an LBT failure at the UE 315-b. In some examples in which the third resource set may be allocated to the UE 315-a using a configured grant, the UE 315-a may report the feedback from the UE 315-b to the network entity 305 for one or multiple configured grants (e.g., the first configured grant, the second configured grant, the third configured grant). For example, the UE 315-a may report feedback from the UE 315-b to the network entity 305 for a configured grant (e.g., each of the multiple configured grants individually) or for multiple configured grants (e.g., jointly).

In some examples, in response to receiving the feedback from the UE 315-b, the UE 315-a may relay (e.g., pass) the feedback information to the network entity 305. Additionally, or alternatively, the UE 315-b may be unable to transmitting feedback to the UE 315-a (e.g., due to an LBT failure). In such an example, the UE 315-a may determine (e.g., infer) that the absence of feedback from the UE 315-b may be an indicator of an LBT failure, and may transmit a negative acknowledgement to the network entity 305. Additionally, or alternatively, in some examples, the UE 315-a may transmit a summary of the feedback report received at the UE 315-a from the UE 315-b. In such an example, the UE 315-a may transmit two-bit feedback to the network entity 305. For example, the UE 315-a may transmit two-bit feedback that may indicate an acknowledgement (e.g., relatively normal operation), a negative acknowledgement due to the UE 315-a failing to successfully complete an LBT procedure, a negative acknowledgement due to the UE 315-b failing to successfully complete an LBT procedure, or a negative acknowledgement due to the UE 315-b failing to successfully decoding the sidelink message. In some examples, the network entity 305 may provide a configuration (or format) to the UE 315-a for feedback reporting from the UE 315-b. In some examples, the UE 315-b may report feedback to the UE 315-a for a configured grant (e.g., each of the multiple configured grants, individually) or multiple configured grants (e.g., jointly). In some examples, in response to receiving feedback from the UE 315-a (e.g., including or based on feedback reported to the UE 315-a from the UE 315-b), the network entity 305 may infer that a failure associated with the negative acknowledgement may be due to the UE 315-b failing to successfully complete an LBT procedure or the UE 315-b failing to successfully decode the sidelink message, for example due to relatively high interference. In such an example, the network entity 305 may configure (or reconfigure) one or more grants (e.g., a dynamic grant or one or more configured grants) at the UE 315-a (e.g., transmit a resource allocation) based on the inferred failure. In some examples, reporting feedback to the network entity 305 based on feedback received at the UE 315-a from the UE 315-b may lead to increased resource utilization of the shared radio frequency spectrum band and increased reliability of wireless communications between the UE 315-a and the UE 315-b, among other possible benefits.

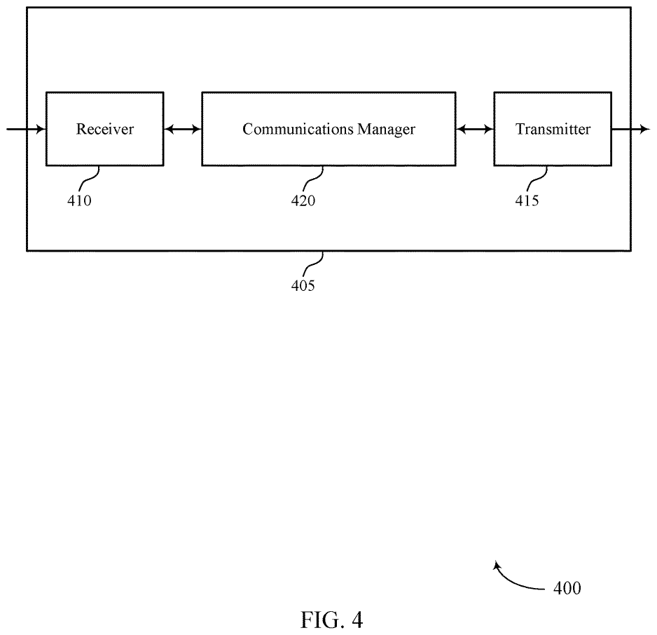

FIG. 4 shows a block diagram 400 of a device 405 that supports Mode-1 sidelink unlicensed operation in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to Mode-1 sidelink unlicensed operation). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to Mode-1 sidelink unlicensed operation). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of Mode-1 sidelink unlicensed operation as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a first UE (e.g., the device 405) in accordance with examples as disclosed herein. For example, the communications manager 420 may be configured as or otherwise support a means for receiving, from a network entity, a first message indicating a request for the first UE to transmit a set of feedback information to the network entity, the set of feedback information associated with transmission of a sidelink message between the first UE and at least a second UE (e.g., another device 405). The communications manager 420 may be configured as or otherwise support a means for receiving, from the network entity, a second message indicating a set of multiple resource sets of a shared radio frequency spectrum band to be used for the transmission of the sidelink message. The communications manager 420 may be configured as or otherwise support a means for transmitting, to the network entity in response to the first message, the set of feedback information corresponding to the transmission of the sidelink message using at least one resource set of the set of multiple resource sets.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources.

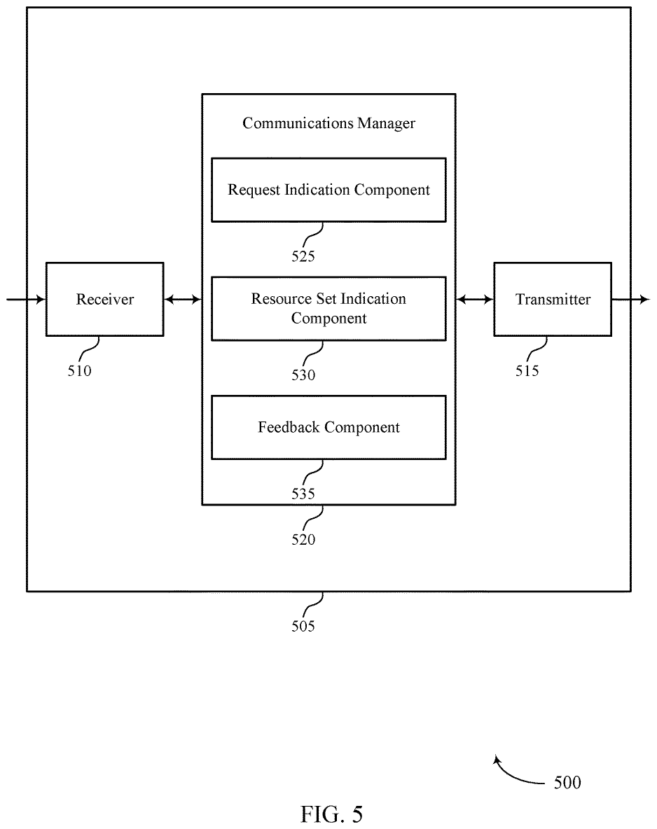

FIG. 5 shows a block diagram 500 of a device 505 that supports Mode-1 sidelink unlicensed operation in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to Mode-1 sidelink unlicensed operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to Mode-1 sidelink unlicensed operation). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of Mode-1 sidelink unlicensed operation as described herein. For example, the communications manager 520 may include a request indication component 525, a resource set indication component 530, a feedback component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first UE (e.g., the device 505) in accordance with examples as disclosed herein. The request indication component 525 may be configured as or otherwise support a means for receiving, from a network entity, a first message indicating a request for the first UE to transmit a set of feedback information to the network entity, the set of feedback information associated with transmission of a sidelink message between the first UE and at least a second UE (e.g., another device 505). The resource set indication component 530 may be configured as or otherwise support a means for receiving, from the network entity, a second message indicating a set of multiple resource sets of a shared radio frequency spectrum band to be used for the transmission of the sidelink message. The feedback component 535 may be configured as or otherwise support a means for transmitting, to the network entity in response to the first message, the set of feedback information corresponding to the transmission of the sidelink message using at least one resource set of the set of multiple resource sets.

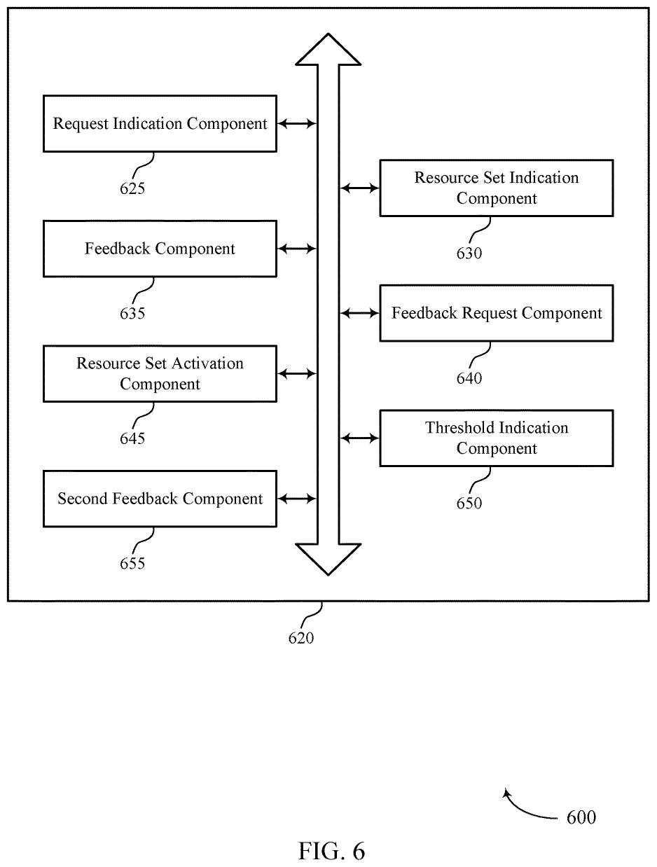

FIG. 6 shows a block diagram 600 of a communications manager 620 that supports Mode-1 sidelink unlicensed operation in accordance with one or more aspects of the present disclosure. The communications manager 620 may be an example of aspects of a communications manager 420, a communications manager 520, or both, as described herein. The communications manager 620, or various components thereof, may be an example of means for performing various aspects of Mode-1 sidelink unlicensed operation as described herein. For example, the communications manager 620 may include a request indication component 625, a resource set indication component 630, a feedback component 635, a feedback request component 640, a resource set activation component 645, a threshold indication component 650, a second feedback component 655, or any combination thereof. Each of these components may communicate, directly or indirectly, with one another (e.g., via one or more buses).

The communications manager 620 may support wireless communication at a first UE in accordance with examples as disclosed herein. The request indication component 625 may be configured as or otherwise support a means for receiving, from a network entity, a first message indicating a request for the first UE to transmit a set of feedback information to the network entity, the set of feedback information associated with transmission of a sidelink message between the first UE and at least a second UE. The resource set indication component 630 may be configured as or otherwise support a means for receiving, from the network entity, a second message indicating a set of multiple resource sets of a shared radio frequency spectrum band to be used for the transmission of the sidelink message. The feedback component 635 may be configured as or otherwise support a means for transmitting, to the network entity in response to the first message, the set of feedback information corresponding to the transmission of the sidelink message using at least one resource set of the set of multiple resource sets.

In some examples, to support transmitting the set of feedback information, the feedback component 635 may be configured as or otherwise support a means for transmitting the set of feedback information, where the set of feedback information includes at least one bit, each bit of the at least one bit corresponding to a respective resource set of the at least one resource set, and each bit indicating that the first UE failed to access a communication channel for transmission of the sidelink message using the respective resource set.

In some examples, to support transmitting the set of feedback information, the feedback component 635 may be configured as or otherwise support a means for transmitting the set of feedback information, where the set of feedback information includes a bit indicating that the first UE failed to access a communication channel for transmission of the sidelink message using the set of multiple resource sets.

In some examples, the threshold indication component 650 may be configured as or otherwise support a means for receiving, from the network entity, an indication of a threshold quantity of resources, where transmitting the set of feedback information is based on the first UE failing to access the communication channel for transmission of the sidelink message using a quantity of resources that satisfies the threshold quantity of resources. In some examples, the quantity of resources are included in one or more resource sets of the set of multiple resource sets.

In some examples, to support transmitting the set of feedback information, the feedback component 635 may be configured as or otherwise support a means for transmitting the set of feedback information including at least two bits, where two bits of the at least two bits correspond to a resource set of the at least one resource set, the two bits indicating that the first UE successfully accessed a communication channel for transmission of the sidelink message using the resource set, that the first UE failed to access a communication channel for transmission of the sidelink message using the resource set, or that the first UE received a negative acknowledgement from the second UE in response to the first UE transmitting the sidelink message using the resource set.

In some examples, to support transmitting the set of feedback information, the feedback component 635 may be configured as or otherwise support a means for transmitting the set of feedback information, where the set of feedback information includes two bits indicating that the first UE successfully accessed a communication channel for transmission of the sidelink message using the set of multiple resource sets, that the first UE failed to access a communication channel for transmission of the sidelink message using the set of multiple resource sets, or that the first UE received a negative acknowledgement from the second UE in response to the first UE transmitting the sidelink message using the set of multiple resource sets.

In some examples, the feedback request component 640 may be configured as or otherwise support a means for transmitting, to the second UE, a third message indicating a request for the second UE to transmit a second set of feedback information to the first UE, where the second set of feedback information associated with the transmission of the sidelink message between the first UE and the second UE, and where the set of feedback information is based on transmission of the third message.

In some examples, the second feedback component 655 may be configured as or otherwise support a means for receiving, from the second UE in response to the third message, the second set of feedback information including a bit that indicates that a received power measured at the second UE satisfies a threshold, where the set of feedback information is based on the second set of feedback information.

In some examples, to support transmitting the set of feedback information, the feedback component 635 may be configured as or otherwise support a means for transmitting, to the network entity, the set of feedback information based on the second set of feedback information, where the set of feedback information includes two bits indicating that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, or that the second UE failed to decode the sidelink message transmitted using the at least one resource set.

In some examples, the resource set indication component 630 may be configured as or otherwise support a means for receiving, from the network entity, a third message indicating a set of resources of a licensed spectrum to be used for transmission of the set of feedback information, where the set of resources is based on the set of feedback information.

In some examples, to support transmitting the set of feedback information, the resource set activation component 645 may be configured as or otherwise support a means for receiving, from the network entity, a third message activating a resource set of the set of multiple resource sets. In some examples, to support transmitting the set of feedback information, the feedback component 635 may be configured as or otherwise support a means for transmitting the set of feedback information including at least one bit indicating that the first UE failed to access a communication channel for transmission of the sidelink message using the activated resource set.

In some examples, the resource set activation component 645 may be configured as or otherwise support a means for receiving, from the network entity in response to the set of feedback information, a fourth message activating a second resource set of the set of multiple resource sets. In some examples, the resource set indication component 630 may be configured as or otherwise support a means for receiving, from the network entity in response to the set of feedback information, a fourth message indicating a resource set unassociated with the set of multiple resource sets.

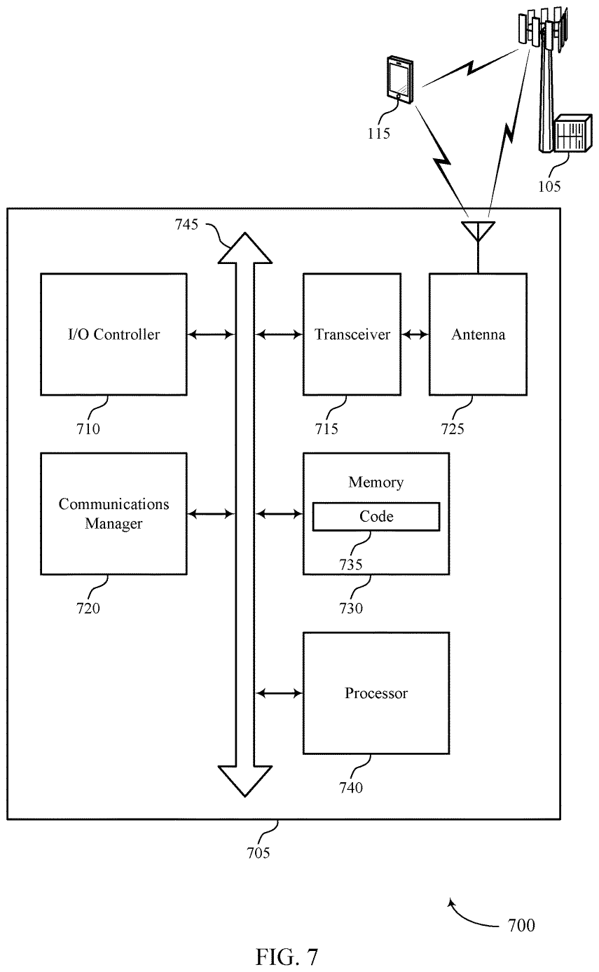

FIG. 7 shows a diagram of a system 700 including a device 705 that supports Mode-1 sidelink unlicensed operation in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting Mode-1 sidelink unlicensed operation). For example, the device 705 or a component of the device 705 may include a processor 740 and memory 730 coupled with or to the processor 740, the processor 740 and memory 730 configured to perform various functions described herein.

The communications manager 720 may support wireless communication at a first UE (e.g., the device 705) in accordance with examples as disclosed herein. For example, the communications manager 720 may be configured as or otherwise support a means for receiving, from a network entity, a first message indicating a request for the first UE to transmit a set of feedback information to the network entity, the set of feedback information associated with transmission of a sidelink message between the first UE and at least a second UE (e.g., another device 705). The communications manager 720 may be configured as or otherwise support a means for receiving, from the network entity, a second message indicating a set of multiple resource sets of a shared radio frequency spectrum band to be used for the transmission of the sidelink message. The communications manager 720 may be configured as or otherwise support a means for transmitting, to the network entity in response to the first message, the set of feedback information corresponding to the transmission of the sidelink message using at least one resource set of the set of multiple resource sets.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of Mode-1 sidelink unlicensed operation as described herein, or the processor 740 and the memory 730 may be otherwise configured to perform or support such operations.

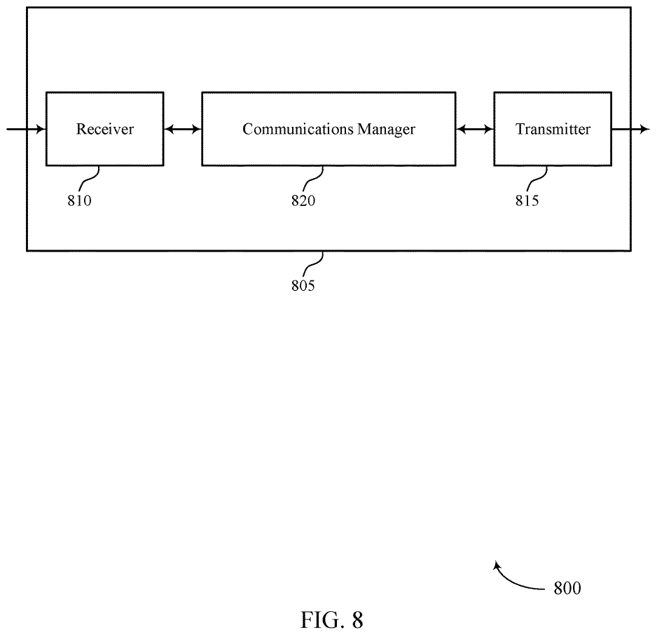

FIG. 8 shows a block diagram 800 of a device 805 that supports Mode-1 sidelink unlicensed operation in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of Mode-1 sidelink unlicensed operation as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity (e.g., the device 805) in accordance with examples as disclosed herein. For example, the communications manager 820 may be configured as or otherwise support a means for outputting, to a first UE, a first message indicating a request for the first UE to transmit a set of feedback information to the network entity, the set of feedback information associated with transmission of a sidelink message between the first UE and at least a second UE. The communications manager 820 may be configured as or otherwise support a means for outputting, to the first UE, a second message indicating a set of multiple resource sets of a shared radio frequency spectrum band to be used for the transmission of the sidelink message. The communications manager 820 may be configured as or otherwise support a means for obtaining, from the first UE in response to the first message, the set of feedback information corresponding to the transmission of the sidelink message using at least one resource set of the set of multiple resource sets.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for more efficient utilization of communication resources.

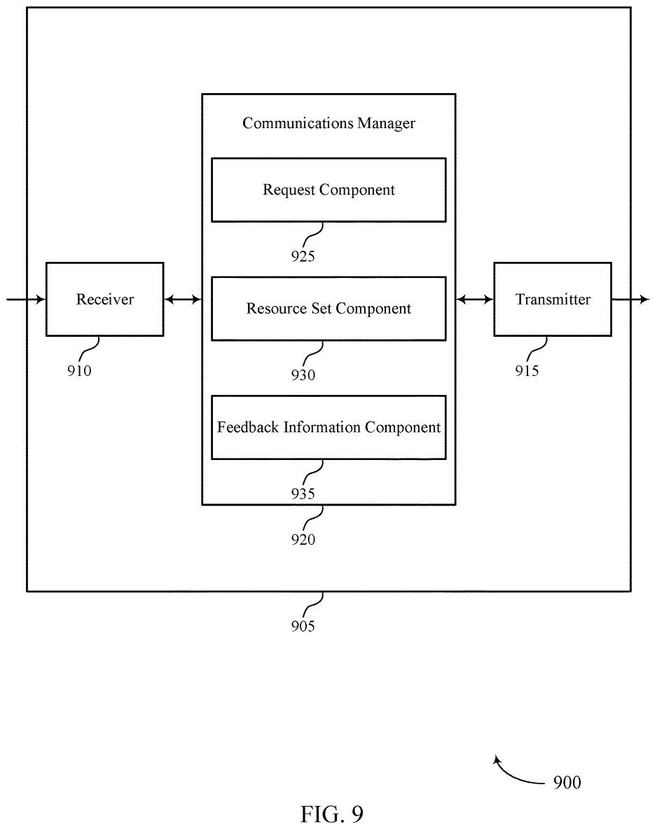

FIG. 9 shows a block diagram 900 of a device 905 that supports Mode-1 sidelink unlicensed operation in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of Mode-1 sidelink unlicensed operation as described herein. For example, the communications manager 920 may include a request component 925, a resource set component 930, a feedback information component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity (e.g., the device 905) in accordance with examples as disclosed herein. The request component 925 may be configured as or otherwise support a means for outputting, to a first UE, a first message indicating a request for the first UE to transmit a set of feedback information to the network entity, the set of feedback information associated with transmission of a sidelink message between the first UE and at least a second UE. The resource set component 930 may be configured as or otherwise support a means for outputting, to the first UE, a second message indicating a set of multiple resource sets of a shared radio frequency spectrum band to be used for the transmission of the sidelink message. The feedback information component 935 may be configured as or otherwise support a means for obtaining, from the first UE in response to the first message, the set of feedback information corresponding to the transmission of the sidelink message using at least one resource set of the set of multiple resource sets.

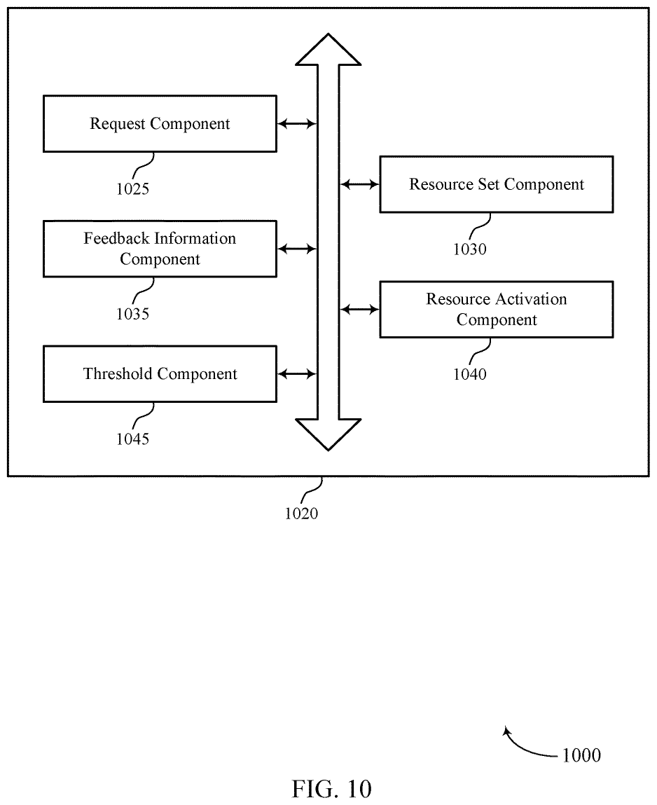

FIG. 10 shows a block diagram 1000 of a communications manager 1020 that supports Mode-1 sidelink unlicensed operation in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of Mode-1 sidelink unlicensed operation as described herein. For example, the communications manager 1020 may include a request component 1025, a resource set component 1030, a feedback information component 1035, a resource activation component 1040, a threshold component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The request component 1025 may be configured as or otherwise support a means for outputting, to a first UE, a first message indicating a request for the first UE to transmit a set of feedback information to the network entity, the set of feedback information associated with transmission of a sidelink message between the first UE and at least a second UE. The resource set component 1030 may be configured as or otherwise support a means for outputting, to the first UE, a second message indicating a set of multiple resource sets of a shared radio frequency spectrum band to be used for the transmission of the sidelink message. The feedback information component 1035 may be configured as or otherwise support a means for obtaining, from the first UE in response to the first message, the set of feedback information corresponding to the transmission of the sidelink message using at least one resource set of the set of multiple resource sets.

In some examples, to support obtaining the set of feedback information, the feedback information component 1035 may be configured as or otherwise support a means for obtaining the set of feedback information, where the set of feedback information includes at least one bit, each bit of the at least one bit corresponds to a respective resource set of the at least one resource set and indicates that the first UE failed to access a communication channel for transmission of the sidelink message using the respective resource set.

In some examples, to support obtaining the set of feedback information, the feedback information component 1035 may be configured as or otherwise support a means for obtaining the set of feedback information, where the set of feedback information includes a bit indicating that the first UE failed to access a communication channel for transmission of the sidelink message using the set of multiple resource sets.

In some examples, to support obtaining the set of feedback information, the threshold component 1045 may be configured as or otherwise support a means for outputting, to the first UE, an indication of a threshold quantity of resources. In some examples, to support obtaining the set of feedback information, the feedback information component 1035 may be configured as or otherwise support a means for obtaining the set of feedback information based on the first UE failing to access the communication channel for transmission of the sidelink message using a quantity of resources that satisfies the threshold quantity of resources. In some examples, the quantity of resources are included in one or more resource sets of the set of multiple resource sets.

In some examples, to support obtaining the set of feedback information, the feedback information component 1035 may be configured as or otherwise support a means for obtaining the set of feedback information, where the set of feedback information includes at least two bits, and where two bits of the at least two bits corresponds to a resource set of the at least one resource set, the two bits indicating that the first UE successfully accessed a communication channel for transmission of the sidelink message using the resource set, that the first UE failed to access a communication channel for transmission of the sidelink message using the resource set, or that the first UE received a negative acknowledgement from the second UE in response to the first UE transmitting the sidelink message using the resource set.

In some examples, to support obtaining the set of feedback information, the feedback information component 1035 may be configured as or otherwise support a means for obtaining the set of feedback information, where the set of feedback information includes two bits indicating that the first UE successfully accessed a communication channel for transmission of the sidelink message using the set of multiple resource sets, that the first UE failed to access a communication channel for transmission of the sidelink message using the set of multiple resource sets, or that the first UE received a negative acknowledgement from the second UE in response to the first UE transmitting the sidelink message using the set of multiple resource sets. In some examples, the set of feedback information is based on a second set of feedback information communicated between the first UE and the second UE.

In some examples, to support obtaining the set of feedback information, the feedback information component 1035 may be configured as or otherwise support a means for obtaining the set of feedback information, where the set of feedback information includes two bits indicating that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, or that the second UE failed to decode the sidelink message transmitted using the at least one resource set. In some examples, the resource set component 1030 may be configured as or otherwise support a means for outputting, to the first UE, a third message indicating a set of resources of a licensed spectrum to be used for transmission of the set of feedback information, where the set of resources is based on the set of feedback information.

In some examples, to support obtaining the set of feedback information, the resource activation component 1040 may be configured as or otherwise support a means for outputting, to the first UE, a third message activating a resource set of the set of multiple resource sets. In some examples, to support obtaining the set of feedback information, the feedback information component 1035 may be configured as or otherwise support a means for obtaining, from the first UE, the set of feedback information including at least one bit indicating that the first UE failed to access a communication channel for transmission of the sidelink message using the activated resource set.

In some examples, the resource activation component 1040 may be configured as or otherwise support a means for outputting, to the first UE in response to the set of feedback information, a fourth message activating a second resource set of the set of multiple resource sets. In some examples, the resource set component 1030 may be configured as or otherwise support a means for outputting, to the first UE in response to the set of feedback information, a fourth message indicating a resource set unassociated with the set of multiple resource sets.

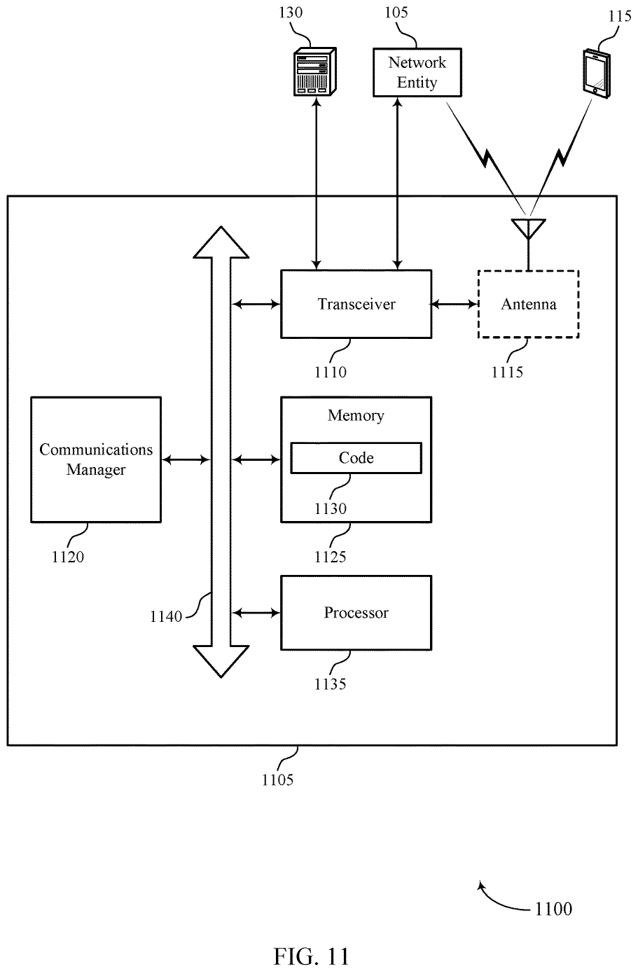

FIG. 11 shows a diagram of a system 1100 including a device 1105 that supports Mode-1 sidelink unlicensed operation in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting Mode-1 sidelink unlicensed operation). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity (e.g., the device 1105) in accordance with examples as disclosed herein. For example, the communications manager 1120 may be configured as or otherwise support a means for outputting, to a first UE, a first message indicating a request for the first UE to transmit a set of feedback information to the network entity, the set of feedback information associated with transmission of a sidelink message between the first UE and at least a second UE. The communications manager 1120 may be configured as or otherwise support a means for outputting, to the first UE, a second message indicating a set of multiple resource sets of a shared radio frequency spectrum band to be used for the transmission of the sidelink message. The communications manager 1120 may be configured as or otherwise support a means for obtaining, from the first UE in response to the first message, the set of feedback information corresponding to the transmission of the sidelink message using at least one resource set of the set of multiple resource sets.

By including or configuring the communications manager 1120 in accordance with examples as described herein, the device 1105 may support techniques for improved communication reliability, more efficient utilization of communication resources, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of Mode-1 sidelink unlicensed operation as described herein, or the processor 1135 and the memory 1125 may be otherwise configured to perform or support such operations.

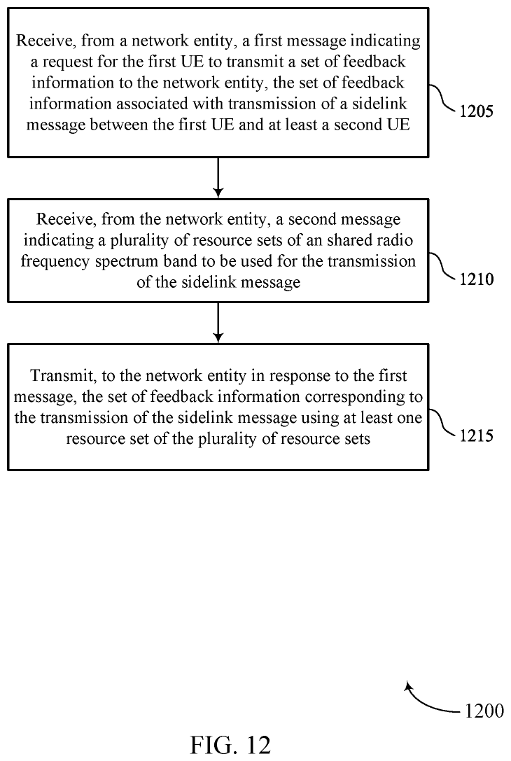

FIG. 12 shows a flowchart illustrating a method 1200 that supports Mode-1 sidelink unlicensed operation in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, a first message indicating a request for the first UE to transmit a set of feedback information to the network entity, the set of feedback information associated with transmission of a sidelink message between the first UE and at least a second UE. The operations of 1205 may be performed in accordance with examples as disclosed herein. In some examples, aspects of the operations of 1205 may be performed by a request indication component 625 as described with reference to FIG. 6.

At 1210, the method may include receiving, from the network entity, a second message indicating a set of multiple resource sets of a shared radio frequency spectrum band to be used for the transmission of the sidelink message. The operations of 1210 may be performed in accordance with examples as disclosed herein. In some examples, aspects of the operations of 1210 may be performed by a resource set indication component 630 as described with reference to FIG. 6.

At 1215, the method may include transmitting, to the network entity in response to the first message, the set of feedback information corresponding to the transmission of the sidelink message using at least one resource set of the set of multiple resource sets. The operations of 1215 may be performed in accordance with examples as disclosed herein. In some examples, aspects of the operations of 1215 may be performed by a feedback component 635 as described with reference to FIG. 6.

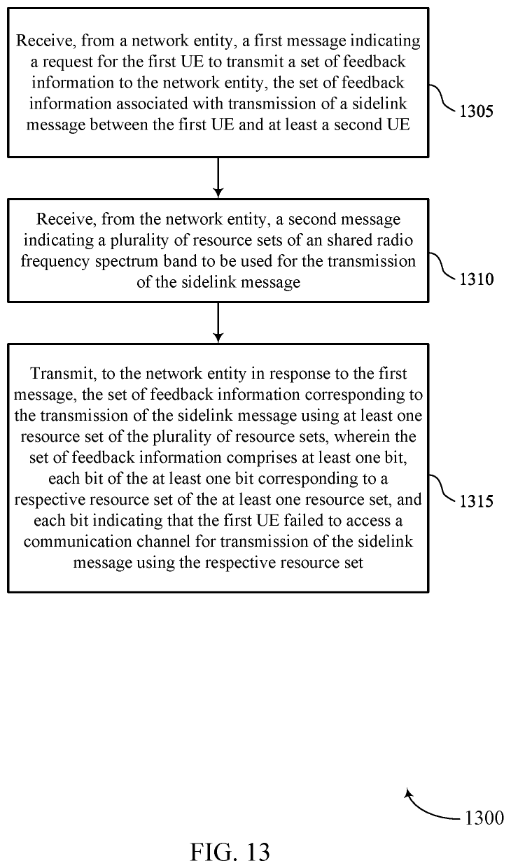

FIG. 13 shows a flowchart illustrating a method 1300 that supports Mode-1 sidelink unlicensed operation in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, a first message indicating a request for the first UE to transmit a set of feedback information to the network entity, the set of feedback information associated with transmission of a sidelink message between the first UE and at least a second UE. The operations of 1305 may be performed in accordance with examples as disclosed herein. In some examples, aspects of the operations of 1305 may be performed by a request indication component 625 as described with reference to FIG. 6.

At 1310, the method may include receiving, from the network entity, a second message indicating a set of multiple resource sets of a shared radio frequency spectrum band to be used for the transmission of the sidelink message. The operations of 1310 may be performed in accordance with examples as disclosed herein. In some examples, aspects of the operations of 1310 may be performed by a resource set indication component 630 as described with reference to FIG. 6.

At 1315, the method may include transmitting, to the network entity in response to the first message, the set of feedback information corresponding to the transmission of the sidelink message using at least one resource set of the set of multiple resource sets, where the set of feedback information includes at least one bit, each bit of the at least one bit corresponding to a respective resource set of the at least one resource set, and each bit indicating that the first UE failed to access a communication channel for transmission of the sidelink message using the respective resource set. The operations of 1315 may be performed in accordance with examples as disclosed herein. In some examples, aspects of the operations of 1315 may be performed by a feedback component 635 as described with reference to FIG. 6.

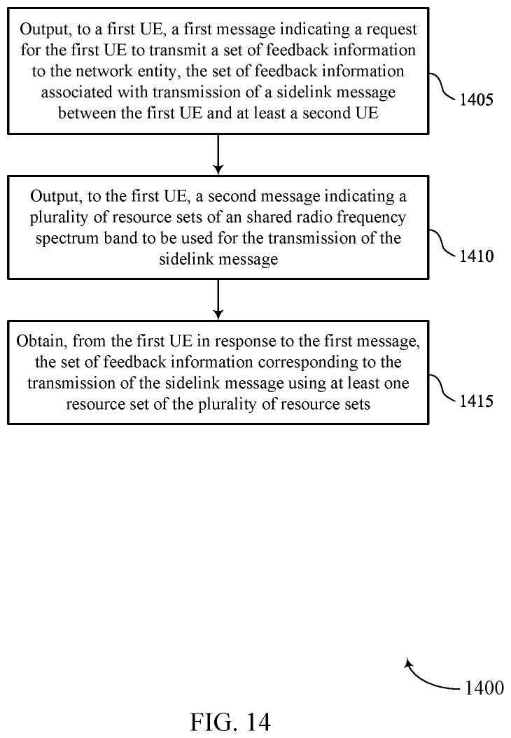

FIG. 14 shows a flowchart illustrating a method 1400 that supports Mode-1 sidelink unlicensed operation in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include outputting, to a first UE, a first message indicating a request for the first UE to transmit a set of feedback information to the network entity, the set of feedback information associated with transmission of a sidelink message between the first UE and at least a second UE. The operations of 1405 may be performed in accordance with examples as disclosed herein. In some examples, aspects of the operations of 1405 may be performed by a request component 1025 as described with reference to FIG. 10.

At 1410, the method may include outputting, to the first UE, a second message indicating a set of multiple resource sets of a shared radio frequency spectrum band to be used for the transmission of the sidelink message. The operations of 1410 may be performed in accordance with examples as disclosed herein. In some examples, aspects of the operations of 1410 may be performed by a resource set component 1030 as described with reference to FIG. 10.

At 1415, the method may include obtaining, from the first UE in response to the first message, the set of feedback information corresponding to the transmission of the sidelink message using at least one resource set of the set of multiple resource sets. The operations of 1415 may be performed in accordance with examples as disclosed herein. In some examples, aspects of the operations of 1415 may be performed by a feedback information component 1035 as described with reference to FIG. 10.

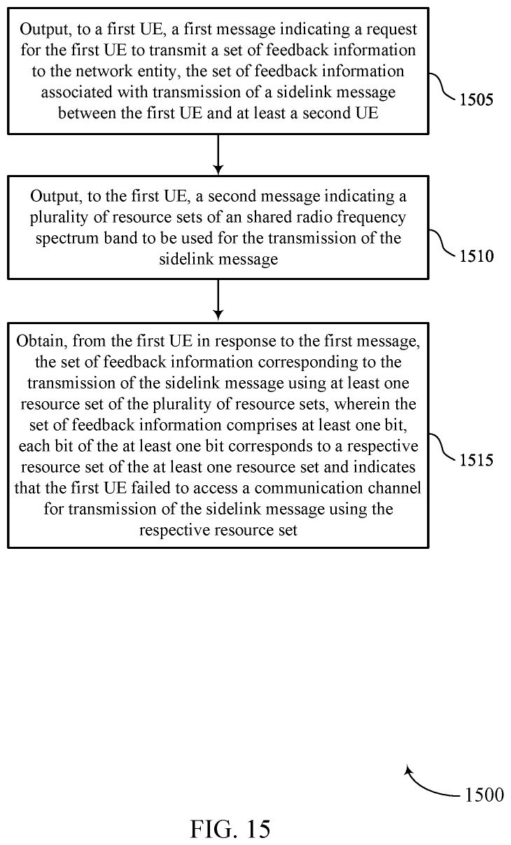

FIG. 15 shows a flowchart illustrating a method 1500 that supports Mode-1 sidelink unlicensed operation in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include outputting, to a first UE, a first message indicating a request for the first UE to transmit a set of feedback information to the network entity, the set of feedback information associated with transmission of a sidelink message between the first UE and at least a second UE. The operations of 1505 may be performed in accordance with examples as disclosed herein. In some examples, aspects of the operations of 1505 may be performed by a request component 1025 as described with reference to FIG. 10.

At 1510, the method may include outputting, to the first UE, a second message indicating a set of multiple resource sets of a shared radio frequency spectrum band to be used for the transmission of the sidelink message. The operations of 1510 may be performed in accordance with examples as disclosed herein. In some examples, aspects of the operations of 1510 may be performed by a resource set component 1030 as described with reference to FIG. 10.

At 1515, the method may include obtaining, from the first UE in response to the first message, the set of feedback information corresponding to the transmission of the sidelink message using at least one resource set of the set of multiple resource sets, where the set of feedback information includes at least one bit, each bit of the at least one bit corresponds to a respective resource set of the at least one resource set and indicates that the first UE failed to access a communication channel for transmission of the sidelink message using the respective resource set. The operations of 1515 may be performed in accordance with examples as disclosed herein. In some examples, aspects of the operations of 1515 may be performed by a feedback information component 1035 as described with reference to FIG. 10.

The following provides an overview of aspects of the present disclosure:
Aspect 1: A method for wireless communication at a first UE, comprising: receiving, from a network entity, a first message indicating a request for the first UE to transmit a set of feedback information to the network entity, the set of feedback information associated with transmission of a sidelink message between the first UE and at least a second UE; receiving, from the network entity, a second message indicating a plurality of resource sets of a shared radio frequency spectrum band to be used for the transmission of the sidelink message; and transmitting, to the network entity in response to the first message, the set of feedback information corresponding to the transmission of the sidelink message using at least one resource set of the plurality of resource sets.
Aspect 2: The method of aspect 1, wherein transmitting the set of feedback information comprises: transmitting the set of feedback information, wherein: the set of feedback information comprises at least one bit, each bit of the at least one bit corresponding to a respective resource set of the at least one resource set, and each bit indicating that the first UE failed to access a communication channel for transmission of the sidelink message using the respective resource set.
Aspect 3: The method of any of aspects 1 through 2, wherein transmitting the set of feedback information comprises: transmitting the set of feedback information, wherein the set of feedback information comprises a bit indicating that the first UE failed to access a communication channel for transmission of the sidelink message using the plurality of resource sets.
Aspect 4: The method of aspect 3, further comprising: receiving, from the network entity, an indication of a threshold quantity of resources, wherein transmitting the set of feedback information is based at least in part on the first UE failing to access the communication channel for transmission of the sidelink message using a quantity of resources that satisfies the threshold quantity of resources.
Aspect 5: The method of aspect 4, wherein the quantity of resources are included in one or more resource sets of the plurality of resource sets.
Aspect 6: The method of aspect 1, wherein transmitting the set of feedback information comprises: transmitting the set of feedback information comprising at least two bits, wherein two bits of the at least two bits correspond to a resource set of the at least one resource set, the two bits indicating: that the first UE successfully accessed a communication channel for transmission of the sidelink message using the resource set, that the first UE failed to access a communication channel for transmission of the sidelink message using the resource set, or that the first UE received a negative acknowledgement from the second UE in response to the first UE transmitting the sidelink message using the resource set.
Aspect 7: The method of aspect 6, wherein transmitting the set of feedback information comprises: transmitting the set of feedback information, wherein the set of feedback information comprises two bits indicating: that the first UE successfully accessed a communication channel for transmission of the sidelink message using the plurality of resource sets, that the first UE failed to access a communication channel for transmission of the sidelink message using the plurality of resource sets, or that the first UE received a negative acknowledgement from the second UE in response to the first UE transmitting the sidelink message using the plurality of resource sets.
Aspect 8: The method of any of aspects 6 and 7, further comprising: transmitting, to the second UE, a third message indicating a request for the second UE to transmit a second set of feedback information to the first UE, wherein the second set of feedback information associated with the transmission of the sidelink message between the first UE and the second UE, and wherein the set of feedback information is based at least in part on transmission of the third message.
Aspect 9: The method of aspect 8, further comprising: receiving, from the second UE in response to the third message, the second set of feedback information comprising a bit that indicates that a received power measured at the second UE satisfies a threshold, wherein the set of feedback information is based at least in part on the second set of feedback information.
Aspect 10: The method of aspect 9, wherein transmitting the set of feedback information comprises: transmitting, to the network entity, the set of feedback information based at least in part on the second set of feedback information, wherein the set of feedback information comprises two bits indicating: that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, or that the second UE failed to decode the sidelink message transmitted using the at least one resource set.
Aspect 11: The method of any of aspects 1 through 10, further comprising: receiving, from the network entity, a third message indicating a set of resources of a licensed spectrum to be used for transmission of the set of feedback information, wherein the set of resources is based at least in part on the set of feedback information.
Aspect 12: The method of any of aspects 1 through 11, wherein transmitting the set of feedback information comprises: receiving, from the network entity, a third message activating a resource set of the plurality of resource sets; and transmitting the set of feedback information comprising at least one bit indicating that the first UE failed to access a communication channel for transmission of the sidelink message using the activated resource set.
Aspect 13: The method of aspect 12, further comprising: receiving, from the network entity in response to the set of feedback information, a fourth message activating a second resource set of the plurality of resource sets.
Aspect 14: The method of aspect 12, further comprising: receiving, from the network entity in response to the set of feedback information, a fourth message indicating a resource set unassociated with the plurality of resource sets.
Aspect 15: A method for wireless communication at a network entity, comprising: outputting, to a first UE, a first message indicating a request for the first UE to transmit a set of feedback information to the network entity, the set of feedback information associated with transmission of a sidelink message between the first UE and at least a second UE; outputting, to the first UE, a second message indicating a plurality of resource sets of a shared radio frequency spectrum band to be used for the transmission of the sidelink message; and obtaining, from the first UE in response to the first message, the set of feedback information corresponding to the transmission of the sidelink message using at least one resource set of the plurality of resource sets.
Aspect 16: The method of aspect 15, wherein obtaining the set of feedback information comprises: obtaining the set of feedback information, wherein the set of feedback information comprises at least one bit, each bit of the at least one bit corresponds to a respective resource set of the at least one resource set and indicates that the first UE failed to access a communication channel for transmission of the sidelink message using the respective resource set.
Aspect 17: The method of any of aspects 15 through 16, wherein obtaining the set of feedback information comprises: obtaining the set of feedback information, wherein the set of feedback information comprises a bit indicating that the first UE failed to access a communication channel for transmission of the sidelink message using the plurality of resource sets.
Aspect 18: The method of aspect 17, wherein obtaining the set of feedback information comprises: outputting, to the first UE, an indication of a threshold quantity of resources; and obtaining the set of feedback information based at least in part on the first UE failing to access the communication channel for transmission of the sidelink message using a quantity of resources that satisfies the threshold quantity of resources.
Aspect 19: The method of aspect 18, wherein the quantity of resources are included in one or more resource sets of the plurality of resource sets.
Aspect 20: The method of aspect 15, wherein obtaining the set of feedback information comprises: obtaining the set of feedback information, wherein the set of feedback information comprises at least two bits, and wherein two bits of the at least two bits corresponds to a resource set of the at least one resource set, the two bits indicating: that the first UE successfully accessed a communication channel for transmission of the sidelink message using the resource set, that the first UE failed to access a communication channel for transmission of the sidelink message using the resource set, or that the first UE received a negative acknowledgement from the second UE in response to the first UE transmitting the sidelink message using the resource set.
Aspect 21: The method of aspect 20, wherein obtaining the set of feedback information comprises: obtaining the set of feedback information, wherein the set of feedback information comprises two bits indicating: that the first UE successfully accessed a communication channel for transmission of the sidelink message using the plurality of resource sets, that the first UE failed to access a communication channel for transmission of the sidelink message using the plurality of resource sets, or that the first UE received a negative acknowledgement from the second UE in response to the first UE transmitting the sidelink message using the plurality of resource sets.
Aspect 22: The method of any of aspects 20 and 21, wherein the set of feedback information is based at least in part on a second set of feedback information communicated between the first UE and the second UE.
Aspect 23: The method of aspect 22, wherein obtaining the set of feedback information comprises: obtaining the set of feedback information, wherein the set of feedback information comprises two bits indicating: that the first UE successfully accessed a communication channel for transmission of the sidelink message using the at least one resource set, that the first UE failed to access a communication channel for transmission of the sidelink message using the at least one resource set, that the second UE failed to receive the sidelink message transmitted using the at least one resource set, or that the second UE failed to decode the sidelink message transmitted using the at least one resource set.
Aspect 24: The method of any of aspects 15 through 23, further comprising: outputting, to the first UE, a third message indicating a set of resources of a licensed spectrum to be used for transmission of the set of feedback information, wherein the set of resources is based at least in part on the set of feedback information.
Aspect 25: The method of any of aspects 15 through 24, wherein obtaining the set of feedback information comprises: outputting, to the first UE, a third message activating a resource set of the plurality of resource sets; and obtaining, from the first UE, the set of feedback information comprising at least one bit indicating that the first UE failed to access a communication channel for transmission of the sidelink message using the activated resource set.
Aspect 26: The method of aspect 25, further comprising: outputting, to the first UE in response to the set of feedback information, a fourth message activating a second resource set of the plurality of resource sets.
Aspect 27: The method of aspect 25, further comprising: outputting, to the first UE in response to the set of feedback information, a fourth message indicating a resource set unassociated with the plurality of resource sets.
Aspect 28: An apparatus for wireless communication at a first UE, comprising a processor; memory coupled with the processor; and instructions stored in the memory and executable by the processor to cause the apparatus to perform a method of any of aspects 1 through 14.
Aspect 29: An apparatus for wireless communication at a first UE, comprising at least one means for performing a method of any of aspects 1 through 14.
Aspect 30: A non-transitory computer-readable medium storing code for wireless communication at a first UE, the code comprising instructions executable by a processor to perform a method of any of aspects 1 through 14.
Aspect 31: An apparatus for wireless communication at a network entity, comprising a processor; memory coupled with the processor; and instructions stored in the memory and executable by the processor to cause the apparatus to perform a method of any of aspects 15 through 27.
Aspect 32: An apparatus for wireless communication at a network entity, comprising at least one means for performing a method of any of aspects 15 through 27.
Aspect 33: A non-transitory computer-readable medium storing code for wireless communication at a network entity, the code comprising instructions executable by a processor to perform a method of any of aspects 15 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first user equipment (UE), comprising:
receiving, from a network entity, a first message indicating a request for the first UE to transmit a set of feedback information to the network entity, the set of feedback information associated with transmission of a sidelink message between the first UE and at least a second UE;
receiving, from the network entity, a second message indicating a plurality of resource sets of a shared radio frequency spectrum band to be used for the transmission of the sidelink message; and
transmitting, to the network entity in response to the first message, the set of feedback information corresponding to the transmission of the sidelink message using at least one resource set of the plurality of resource sets.

2. The method of claim 1, wherein transmitting the set of feedback information comprises:
transmitting the set of feedback information, wherein;
the set of feedback information comprises at least one bit,
each bit of the at least one bit corresponding to a respective resource set of the at least one resource set, and
each bit indicating that the first UE failed to access a communication channel for transmission of the sidelink message using the respective resource set.

3. The method of claim 1, wherein transmitting the set of feedback information comprises:
transmitting the set of feedback information, wherein the set of feedback information comprises a bit indicating that the first UE failed to access a communication channel for transmission of the sidelink message using the plurality of resource sets.

4. The method of claim 3, further comprising:
receiving, from the network entity, an indication of a threshold quantity of resources, wherein transmitting the set of feedback information is based at least in part on the first UE failing to access the communication channel for transmission of the sidelink message using a quantity of resources that satisfies the threshold quantity of resources.

5. The method of claim 4, wherein the quantity of resources are included in one or more resource sets of the plurality of resource sets.

6. The method of claim 1, wherein transmitting the set of feedback information comprises:
transmitting the set of feedback information comprising at least two bits, wherein two bits of the at least two bits correspond to a resource set of the at least one resource set, the two bits indicating:
that the first UE successfully accessed a communication channel for transmission of the sidelink message using the resource set,
that the first UE failed to access a communication channel for transmission of the sidelink message using the resource set, or
that the first UE received a negative acknowledgement from the second UE in response to the first UE transmitting the sidelink message using the resource set.

7. The method of claim 1, wherein transmitting the set of feedback information comprises:
transmitting the set of feedback information, wherein the set of feedback information comprises two bits indicating:
that the first UE successfully accessed a communication channel for transmission of the sidelink message using the plurality of resource sets,
that the first UE failed to access a communication channel for transmission of the sidelink message using the plurality of resource sets, or
that the first UE received a negative acknowledgement from the second UE in response to the first UE transmitting the sidelink message using the plurality of resource sets.

8. The method of claim 1, further comprising:
transmitting, to the second UE, a third message indicating a request for the second UE to transmit a second set of feedback information to the first UE, wherein the second set of feedback information associated with the transmission of the sidelink message between the first UE and the second UE, and wherein the set of feedback information is based at least in part on transmission of the third message.

9-10. (canceled)

10. The method of claim 1, further comprising:
receiving, from the network entity, a third message indicating a set of resources of a licensed spectrum to be used for transmission of the set of feedback information, wherein the set of resources is based at least in part on the set of feedback information.

11. The method of claim 1, wherein transmitting the set of feedback information comprises:
receiving, from the network entity, a third message activating a resource set of the plurality of resource sets; and
transmitting the set of feedback information comprising at least one bit indicating that the first UE failed to access a communication channel for transmission of the sidelink message using the activated resource set.

12. The method of claim 12, further comprising:
receiving, from the network entity in response to the set of feedback information, a fourth message activating a second resource set of the plurality of resource sets.

13. The method of claim 12, further comprising:
receiving, from the network entity in response to the set of feedback information, a fourth message indicating a resource set unassociated with the plurality of resource sets.

14. A method for wireless communication at a network entity, comprising:
outputting, to a first user equipment (UE), a first message indicating a request for the first UE to transmit a set of feedback information to the network entity, the set of feedback information associated with transmission of a sidelink message between the first UE and at least a second UE;
outputting, to the first UE, a second message indicating a plurality of resource sets of a shared radio frequency spectrum band to be used for the transmission of the sidelink message; and
obtaining, from the first UE in response to the first message, the set of feedback information corresponding to the transmission of the sidelink message using at least one resource set of the plurality of resource sets.

15. (canceled)

16. The method of claim 15, wherein obtaining the set of feedback information comprises:
obtaining the set of feedback information, wherein the set of feedback information comprises a bit indicating that the first UE failed to access a communication channel for transmission of the sidelink message using the plurality of resource sets.

17. The method of claim 17, wherein obtaining the set of feedback information comprises:
outputting, to the first UE, an indication of a threshold quantity of resources; and
obtaining the set of feedback information based at least in part on the first UE failing to access the communication channel for transmission of the sidelink message using a quantity of resources that satisfies the threshold quantity of resources.

18. The method of claim 18, wherein the quantity of resources are included in one or more resource sets of the plurality of resource sets.

19-24. (canceled)

20. The method of claim 15, wherein obtaining the set of feedback information comprises:
outputting, to the first UE, a third message activating a resource set of the plurality of resource sets; and
obtaining, from the first UE, the set of feedback information comprising at least one bit indicating that the first UE failed to access a communication channel for transmission of the sidelink message using the activated resource set.

21. The method of claim 25, further comprising:
outputting, to the first UE in response to the set of feedback information, a fourth message activating a second resource set of the plurality of resource sets.

22. The method of claim 25, further comprising:
outputting, to the first UE in response to the set of feedback information, a fourth message indicating a resource set unassociated with the plurality of resource sets.

23. An apparatus for wireless communication at a first user equipment (UE), comprising:
a processor;
memory coupled with the processor, and instructions stored in the memory and executable by the processor to cause the apparatus to:
receive, from a network entity, a first message indicating a request for the first UE to transmit a set of feedback information to the network entity, the set of feedback information associated with transmission of a sidelink message between the first UE and at least a second UE;
receive, from the network entity, a second message indicating a plurality of resource sets of a shared radio frequency spectrum band to be used for the transmission of the sidelink message; and
transmit, to the network entity in response to the first message, the set of feedback information corresponding to the transmission of the sidelink message using at least one resource set of the plurality of resource sets.

24-30. (canceled)
